(19) United States
(12) Patent Application Publication
(10) Pub. No.: US 2026/0061991 A1
(43) Pub. Date: Mar. 5, 2026

(54) OBTAINING PARKING ZONES FOR PICK UP AND DROP OFF

(71) Applicant: Zoox, Inc., Foster City, CA (US)

(72) Inventors: Rossitza Dimitrova Kotelova, San Francisco, CA (US); Steven Patrick Krukowski, San Francisco, CA (US); Steven Cheng Qian, San Francisco, CA (US); Joshua Adam Redel, San Francisco, CA (US); Theresa Kurth Rivera, Livermore, CA (US)

(21) Appl. No.: 18/822,164

(22) Filed: Aug. 31, 2024

(51) Int. Cl. B60W 30/06; B60W 60/00

(52) U.S. Cl. CPC B60W 30/06; B60W 60/00253; B60W 2540/041

(57) ABSTRACT

Techniques for generating and/or utilizing parking zones for pickup and/or drop off scenarios are described herein. A vehicle (such as an autonomous vehicle) may receive a request to transport a passenger from a starting location to a destination location. The request may include or otherwise be associated with a parking zone proximate the starting location within which the vehicle is to pick up the passenger. The vehicle may navigate to the parking zone and identify the one or more parking spaces within the parking zone. The vehicle may determine a subset of the parking spaces based on parameters associated with the parking zone (e.g., filter out non-conforming parking spaces). The vehicle can generate candidate actions (e.g., trajectories) to the subset of parking spaces, determine a control trajectory that leads to one of the parking spaces, and control the vehicle based on the control trajectory.

### BACKGROUND

Vehicles, such as autonomous vehicles, may navigate along designated routes or between waypoints. For example, vehicles can receive a request to transport a passenger from a starting location to a destination location. In this example, the autonomous vehicle may be required to park in order to pick up or drop off the passenger at the pickup and drop off location(s). However, in some circumstances, techniques for picking up and/or dropping off passenger(s) may result in the vehicle navigating to suboptimal parking spaces and/or failing to abide by other rules and/or expectations.

### BRIEF DESCRIPTION OF THE DRAWINGS

FIG. 1 is a pictorial flow diagram illustrating an example technique for receiving and/or using parking zones when picking up and/or dropping off passenger(s), in accordance with one or more examples of the disclosure.

FIG. 2 illustrates an example computing system including a parking management component configured to generate parking zones, a ridesharing component configured to use the parking zones to facilitate the requesting of a ride, and/or a planning component configured to use the parking zones when picking up and/or dropping off passengers, in accordance with one or more examples of the disclosure.

FIG. 3 is an example environment that illustrates example parking zones spanning various regions of a driving environment, in accordance with one or more examples of the disclosure.

FIG. 4 is a pictorial flow diagram illustrating an example process for updating parking zones stored in a database accessible to a fleet of vehicles, in accordance with one or more examples of the disclosure.

FIGS. 5A and 5B are a pictorial flow diagram illustrating an example process for requesting a ride via a user device based on the parking zones, in accordance with one or more examples of the disclosure.

FIG. 6 depicts a block diagram of an example system for implementing various techniques described herein.

FIG. 7 is a flow diagram illustrating an example process for receiving a request to transport a passenger, identify parking spaces based on parking zone(s) associated with the request, and/or controlling the vehicle based on the parking spaces, in accordance with one or more examples of the disclosure.

FIG. 8 is a flow diagram illustrating an example process for leveraging parking zones when requesting a ride from an autonomous vehicle using a user device, in accordance with one or more examples of the disclosure.

### DETAILED DESCRIPTION

This application relates to determining, designating, and utilizing parking zones for pickup and/or drop off scenarios. In some examples, a vehicle (such as an autonomous vehicle) may receive a request to transport a passenger from a starting location to a destination location. The request may include or otherwise be associated with a parking zone proximate the starting location within which the vehicle is to pick up the passenger. In such cases, the vehicle may navigate to the parking zone and identify the one or more parking spaces within the parking zone. The vehicle may determine a subset of the parking spaces based on parameters associated with the parking zone (e.g., filter out non-conforming parking spaces). In some examples, the vehicle can generate candidate actions (e.g., trajectories) to use to navigate to individual parking spaces of the subset of parking spaces, determine a control trajectory from among the candidate actions/trajectories that leads to one of the parking spaces, and control the vehicle based on the control trajectory. As described in more detail below, the techniques described herein may improve vehicle safety, driving efficiency, and/or parking efficiency by increasing the ability of the vehicle to abide by rules of the road and/or expectations of the environment when performing pickup and drop off maneuvers.

When picking up and/or dropping off a passenger in an environment, it may be beneficial to allow flexible pickup and/or drop off locations while also conforming to the rules and expectations of vehicles parking in such spots. For example, a vehicle can receive a request to pick up a future passenger at a specific location. In this case, the vehicle may provide an exact location to the future passenger that indicates where the passenger can expect to be picked up by the vehicle. However, in some circumstances, the location provided by the vehicle may be suboptimal and/or may not conform to the rules and/or expectations of vehicles parking in such locations. That is, in some cases, different regions of the environment may include different expectations and/or rules for when and/or how vehicles are to park in such regions and as vehicles being parking in different regions, the vehicles may lack important information as to where and/or how to park. For example, in some cases the location selected by the vehicle may require the future passenger to walk a large distance in order to be picked up by the vehicle and/or may require the future passenger to walk in (or through) suboptimal region(s) of the environment (e.g., across a busy street) to arrive at the pickup location. Alternatively or additionally, the location selected by the vehicle may require the vehicle to perform certain operations which may fail to conform to the rules or expectations of vehicles parking at the location (e.g., obstructing traffic or a pedestrian walkway). As such, the techniques and/or systems described herein include allowing the future passenger to select a zone (from one or more zones) to be picked up while also increasing the ability of the vehicle to follow the rules of such regions.

To address these and other technical problems and inefficiencies, the systems and/or techniques described herein may include a parking management component (which also may be referred to as a “parking manager” or “parking management system”) configured to obtain parking zones to provide added flexibility to passengers while also increasing the ability of the vehicle to follow rules and/or expectations of the environment. Technical solutions discussed herein solve one or more technical problems associated with the vehicle navigating to suboptimal parking spaces and/or failing to abide by other rules and/or expectations of the environment or third parties.

In some examples, the parking management component may generate parking zones during a pre-computation stage. The pre-computation stage may be before the vehicle turns on, initializes, etc. That is, the pre-computation stage may occur before the vehicle has started navigating the environment. A parking zone may be geofence-like area that covers a region of the environment and that includes one or more parameters representing characteristic(s) of the parking zone. As described below, the parking management component may send the parking zone(s) to some or all vehicles in a fleet of vehicles.

For example, when generating the parking zone(s), the parking management component may receive map data. Map data may include information about the static object(s) and/or features of the environment such as road segment data, driving lane data, lane segment data, static object data (e.g., object type, object location, object characteristics, etc.), junction data, etc.

In some examples, the parking management component may generate the parking zone(s) based on the map data. As noted above, a parking zone may be a bounded region of the environment within which the vehicle can pickup and/or drop off a passenger. The size and/or dimensions of the parking zone(s) may be based on or correspond to a road segment, a driving lane, a lane segment, and/or the direction of travel associated therewith. Further, the size and/or dimensions may be based on environmental features such as the presence of fire hydrants, red curbs, allowable parking maneuvers, etc. As such, in these examples, the length of a parking zone may end a threshold distance from a fire hydrant such that the parking zone is not directly in front of the fire hydrant. In other examples, the parking management component may divide a single road segment, driving lane, and/or lane segment into multiple driving zones based on one portion allowing a first type of parking maneuver (e.g., parallel parking, perpendicular parking, double parking, curbside parking, etc.) and a second portion prohibiting such maneuvers.

In some examples, the parking zone(s) may include one or more parameters (or features) which may represent characteristics of the parking zone. The parking management component may receive the parameters from map data, third party resources (e.g., airports, hotels, cities, etc.), etc. The parameters may indicate which parking maneuvers are allowed or acceptable within the parking zone (e.g., curbside parking, double parking, perpendicular parking, parallel parking, etc.), a type of vehicle allowed to park within the zone (e.g., level 3 vehicle, level 5 vehicle, bidirectional vehicle, manual vehicle, etc.), an ability of a future passenger to select where to get picked up within the zone (e.g., some parking zones may be restricted such that there is only a limited number of pickup spots within the zone), etc. The parking management component may attach (e.g., encode) the parameter(s) to the associated parking zone(s).

In some examples, the parking management component may send the parking zones to a fleet of vehicles. That is, a fleet management component may manage and/or control the operation of a fleet of one or more vehicles within a specified geofence. In such cases, the fleet of vehicles may share a database that can include the parking zones. For example, the parking management component may send the parking zones to the database and the vehicles in the fleet may access the database and/or the parking zones stored therein while the vehicles navigate the environment.

In some examples, the list of available parking zones in the database may be updated while the fleet of vehicles operate within the environment. That is, one or more vehicle systems may remove or add parking zones to the list of available parking zones in the database. Updating the available parking zones allows the vehicle to leverage real-time data to inform the fleet of vehicles of the available or unavailable parking zones within a region. In some examples, the list of available parking zones may be updated by the vehicles in the fleet and/or by one or more remote systems. For instance, the fleet of vehicles may capture sensor data of the environment and determine that an event has taken place such as an emergency in the road, construction, a road closure, etc. In such cases, the vehicle can update the database by indicating that the zone(s) that overlap with the event(s) are unavailable for a period of time. Additionally or alternatively, the remote systems may receive sensor data from the fleet of vehicles, detect an event, and update the database accordingly. Further, the remote systems may receive data from third party sources that indicate road closures, events, etc. that may impact travel and as such, the remote systems may update the availability of the parking zones accordingly.

When updating the list of available parking zones in the database, the remote systems and/or the vehicle may remove or add an entire parking zone or a portion of the parking zone (e.g., modify the dimensions of the parking zone). That is, if an emergency is taking place on a subset of a parking zone (e.g., less than the entire parking zone), the remote system and/or vehicle may remove the entire parking zone from the list of available parking zones. Alternatively, the remote system and/or the vehicle may modify the dimensions of the parking zone such that the available portion of the parking zone does not include the area of the emergency.

After generating the parking zones, the vehicle may leverage the parking zones during the ride requesting process, the passenger picking up process, and/or the passenger drop off process.

For example, a user may use a user device to request a ride (e.g., be transported from a starting location to a destination location). That is, the passenger may include a device which may be used to request rides from the vehicle. The device may be a mobile device (e.g., phone, wearable, tablet, etc.) or a stationary device (e.g., desktop, etc.). The passenger can use the device to access a ridesharing platform which may include a ride requesting interface. The ride requesting interface may allow the passenger to request a ride from a starting location to a destination location.

In such cases, the ridesharing platform may receive, from a passenger, a request for a ride from a starting location to a destination location. The request may include a starting location and/or a destination location as input to the ride requesting interface by the passenger. The starting location and/or the destination location may be exact locations, buildings, range of locations (e.g., range of coordinates), etc. In such cases, the passenger may submit the ride request to the rideshare platform to request a ride.

Based on receiving the request and the parking zones, the rideshare platform may display one or more recommended pickup and drop off locations. That is, the rideshare platform may receive the parking zones (or map data) and determine the closest zone to the starting location included in the request. Additionally or alternatively, the pickup zone may be determined based on a convenience level, a speed at which the vehicle can get to the destination location from the parking space, a safety of the user, etc. Based on identifying the parking zones or parking spaces within a threshold distance to the requested pickup location, the rideshare platform may display a location associated with such parking zones or parking spaces to the device.

In such cases, the passenger may accept or reject the recommended pickup and drop off locations. That is, the passenger may view the recommended pickup and drop off locations and indicate that such locations are rejected. Based on rejecting the locations, the rideshare platform may cause the parking zones to be displayed via a user interface of the device. In such cases, the passenger may select, from the one or more pickup zones, a parking zone at which the passenger would like to be picked up and dropped off. In such cases, the rideshare platform may receive user input data that indicates that the user has selected a parking zone and/or confirmed the ride. Based on the user input data, the rideshare platform may send the request to a vehicle in the fleet. Upon receiving the request, the vehicle may proceed by navigating to and/or picking up the passenger.

From the perspective of the vehicle, the vehicle may receive a request to transport a passenger from a starting location to an ending location. The request may include passenger data (e.g., passenger profile, passenger description, etc.), pickup zone (e.g., parking zone), and/or drop off zone (e.g., parking zone). In such cases, the vehicle may navigate to the pickup zone. Additionally or alternatively, the request may include an exact pickup location and/or may lack a parking zone. In such cases, the vehicle may identify the parking zone(s) by accessing the parking zones stored in the database and determining which parking zone(s) are associated with the starting location (e.g., which parking zone is the starting location located within).

Based on being within or otherwise within a threshold distance from the parking zone, the vehicle may identify candidate parking spaces within the parking zone. As noted above, the parking zone may include allowable parking maneuvers and/or one or more parameters which may indicate expectations and/or rules for the vehicle to follow within the zone. For example, the parameters of the parking zone may indicate that the vehicle can only perform a perpendicular parking maneuver in the parking zone. As such, the vehicle may receive the parking spaces within the pickup zone (from map data) that include a perpendicular parking maneuver. That is, the vehicle may filter through the one or more parking spaces within the pickup zone to identify the parking spaces that satisfy (or conform to) the parameters of the parking zone. As such, the vehicle may identify a subset of parking spaces (e.g., potentially less than all the parking spaces within the parking zone).

Based on identifying the parking spaces, the vehicle may generate one or more candidate actions that lead to such parking spaces. A candidate action may be a trajectory that includes a spatial representation of future movements of the vehicle in addition to one or more vehicle controls (e.g., velocity, acceleration, yaw, steering angle, etc.). That is, the candidate actions may include instructions that instruct the vehicle as to how to navigate a portion of the environment. The candidate actions can include instructions that cause the vehicle to perform a parking maneuver. In some examples, a candidate action may include multiple predicted states that can represent the state information of the vehicle at a specific location along the candidate action. State information may include location data, pose data (e.g., lateral offset data, longitudinal offset data, heading offset data), velocity data, acceleration data, and/or other types of data. Examples of various techniques for generating planner actions (or trajectories) for autonomous vehicles can be found, for example, in U.S. Pat. No. 10,921,811, filed on Jan. 22, 2018, issued on Feb. 16, 2021, and titled, “Adaptive Autonomous Vehicle Planner Logic,” in U.S. patent application Ser. No. 18/540,642, filed Dec. 14, 2023, and titled “Machine-Learned Cost Estimation in Tree Search Trajectory Generation for Vehicle Control,” in U.S. Pat. No. 11,875,678, filed on Jan. 21, 2021 and issued on Jan. 16, 2024, and titled “Unstructured Vehicle Path Planner,” in U.S. application Ser. No. 18/087,689, filed on Dec. 22, 2022 and titled, “Parking Location Filter,” and in U.S. Pat. No. 10,955,851, filed on Feb. 14, 2018, issued on Mar. 23, 2021, and titled, “Detecting Blocking Objects,” each of which is incorporated by reference herein in its entirety and for all purposes.

In some examples, the vehicle may generate a control trajectory which may be a combination of the one or more candidate actions. That is, to determine which of the one or more candidate actions to follow, the vehicle may use a tree structure. Accordingly, the vehicle may generate a tree structure that includes some or all of the candidate actions. A tree structure may include one or more nodes representing vehicle states at different action layers of the tree structure. Further, each vehicle state may include multiple candidate actions which the vehicle may follow. As described in more detail below, the planning component may use the tree structure to determine or otherwise select one or more of the candidate actions to follow from a node in the tree structure to a different node at the next layer of the tree structure. The planning component may determine which candidate actions to follow between layers of nodes based on one or more costs. Example techniques for generating a tree structure and determining a control trajectory based on the tree structure can be found, for example, in U.S. application Ser. No. 17/900,658 , filed Aug. 21, 2022, and titled “Trajectory Prediction Based on a Decision Tree,” the contents of which is herein incorporated by reference in its entirety and for all purposes.

In some examples, the vehicle can determine a control trajectory based on the tree structure. The vehicle can evaluate some or all candidate actions when determining a control trajectory. A solution to the tree may result in a series of nodes of the one or more candidate actions which, when traversed (e.g., moving along and between differing trajectories and/or action layers of the tree structure), results in a control trajectory (e.g., output trajectory) having a lowest determined overall cost. An overall cost for the control trajectory may represent and/or be indicative of the combination of one or more sub-costs. A cost value can indicate the safety, progress, comfort, risk, convenience, and/or efficiency of a candidate trajectory. For instance, a high cost value may indicate heightened degree of risk, danger, inconvenience, discomfort, and/or inefficiency of the trajectory. In contrast, a low cost value may indicate a lower degree of risk, danger, inconvenience, and/or inefficiency of the trajectory. In some examples, sub-costs may include parking related costs, comfort related costs (e.g., acceleration cost, jerk cost, steering cost, path reference cost, etc.), legality related costs, policy related costs, safety related costs (e.g., lane changing costs), progress costs, debris cost, a lane blocking cost, a lane ending cost, an exit cost, an approach cost, a space cost, a payment cost, a yaw cost, adversarial cost(s), lane targeting cost (e.g., cost associated with the vehicle being located in a desired lane), cyclist related cost(s), and/or any other type of cost.

Upon determining the one or more sub-costs, the vehicle may determine or otherwise combine the sub-costs into a single overall cost. In various examples, differing cost types may be associated with differing weights based on, for example, importance. As a non-limiting examples, a parking cost or a safety cost may be associated with a higher weight than a comfort cost. Further, such costs may be weighted differently, and as such, different costs may affect the overall cost in different proportions. In some examples, the vehicle may determine to follow a control trajectory that has the lowest overall cost compared to the overall costs of other potential traversal paths between the candidate trajectories.

In some examples, the vehicle may follow the control trajectory to a parking space. Upon determining the control trajectory from the tree search, the vehicle may follow the control trajectory to a parking space within the parking zone. As such, the vehicle may be controlled based on the parking zone. In some examples, the vehicle may perform similar or identical operations when dropping off the passenger.

The techniques described herein can improve the functioning, safety, and efficiency of the autonomous and semi-autonomous vehicles operating in various driving environments. Determining parking zones can allow flexibility to the vehicle as to where to park while also providing additional insight as to how the vehicle can abide by the rules and expectations of the environment. Further, such parking zones may allow an increased passenger experience as such passengers may be able to customize the ride experience by selecting where to get picked up or dropped off from a variety of parking zones. Further, in some examples, the parking zones may enable the vehicle to increase the safety of such pickup and/or drop off maneuvers for the passenger and/or for the vehicle itself.

The techniques described herein may be implemented in several ways. Example implementations are provided below with reference to the following figures. Although discussed in the context of an autonomous vehicle, the methods, apparatuses, and systems described herein may be applied to a variety of systems, and are not limited to autonomous vehicles. In another example, the techniques may be utilized in an aviation or nautical context, or in any other system. Additionally, the techniques described herein may be used with real data (e.g., captured using sensor(s)), simulated data (e.g., generated by a simulator), or any combination of the two.

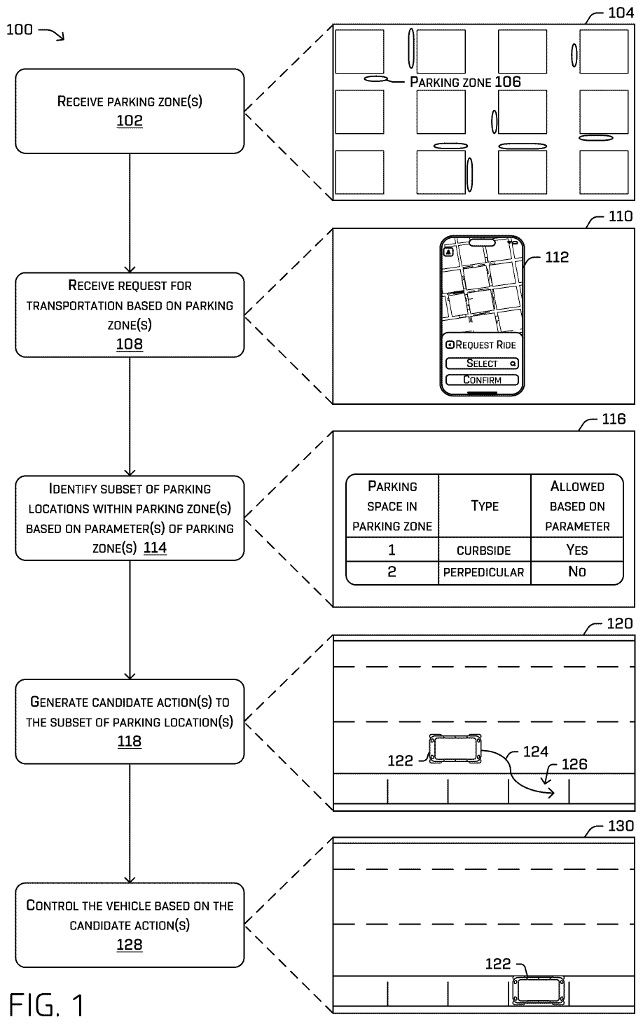

FIG. 1 is a pictorial flow diagram illustrating an example process 100 for receiving and/or using parking zones when picking up and/or dropping off passenger(s). As shown in this example, some or all of the operations in the example process 100 may be performed by a perception component, prediction component, planning component, parking management component, ridesharing component, and/or any other component or system associated with an autonomous vehicle.

At operation 102, the vehicle may receive parking zones. That is, during a pre-computation stage (e.g., before the vehicle turns on, initializes, etc.) a parking management component may generate parking zones which may be a geofence-like area that encompasses one or more parking spaces. The parking management component may generate the parking zones based on receiving map data and/or third party data (e.g., hotel data, airport data, city data, etc.). The size and/or dimensions of a parking zone may be based on the road segments, driving lanes, lane segments, direction of travel, fire hydrants, red curbs, etc. For example, box 104 illustrates an example environment with parking zones. In this example, the box 104 may include one or more driving lanes and/or one or more intersections (or junctions). As such, the example environment may include locations from which passenger(s) request to be picked up and/or dropped off. In such cases, the parking zones may represent areas of the environment within which the passenger may be picked up. In this example, box 104 may include parking zone 106 which may span a portion (e.g., less than all) of a road segment or driving lane. In such cases, the parking zone 106 may encompass one or more parking spaces. Based on generating such parking zones, the parking management component may send the parking zones to vehicle(s) within a fleet of vehicles.

At operation 108, the vehicle may receive a request for transportation based on the parking zone(s) described in operation 102. A potential passenger may use a user device to access a ridesharing application to request a ride from a vehicle. For example, box 110 illustrates a mobile device 112 used to request a ride. In this example, the potential passenger may input a starting and ending location and the ridesharing application may determine recommended and/or alternative locations based on the parking zones. That is, the ridesharing application may retrieve the parking zones to determine where the vehicle can pickup the potential passenger and provide such recommendations to the potential passenger. If the potential passenger rejects the recommended and/or alternative locations, the ridesharing application may display the parking zones proximate the potential passenger and allow the potential passenger to select where to get picked up from one or the parking zones. Based one the potential passenger selecting a parking zone, the ridesharing application may send the request and/or the parking zone to a vehicle.

At operation 114, the vehicle may identify a subset of parking locations within the parking zone based on parameter(s) of the parking zone. As noted above, the parking zone may include one or more parameters which may indicate characteristics of the parking zone. The parameters may indicate which parking maneuvers are allowed or acceptable within the parking zone (e.g., curbside parking, double parking, perpendicular parking, parallel parking, etc.), a type of vehicle allowed to park within the zone (e.g., level 3 vehicle, level 5 vehicle, bidirectional vehicle, manual vehicle, etc.), an ability of a future passenger to select where to get picked up within the zone (e.g., some parking zones may be restricted such that there is only a limited number of pickup spots within the zone), etc. Accordingly, based on receiving the request, the vehicle may navigate to the parking zone and identify the parking spaces (based on map data) within the parking zone. The vehicle may filter through the parking spaces to identify the parking spaces that conform or satisfy the parameters. For example, box 116 illustrates a table with the parking spaces within a parking zone and whether such parking spaces satisfy the parameters of the parking zone. In this example, the table indicates that the parking zone includes a first parking space and a second parking space. The table further indicates that the first parking space is a curbside parking space type and/or the second parking space is a perpendicular parking space type. In this case, the parameters of the parking zone indicate that the vehicle can park in curbside parking and parallel parking spaces. As such, in this case, the vehicle can filter out the second parking space since the second parking space fails to satisfy the allowable type of parking space as designated by the parking space parameters. However, the first parking space may be included in further operations.

At operation 118, the vehicle may generate candidate actions to the subset of parking locations. That is, upon identifying the available and/or allowable parking spaces within the parking zone, the vehicle may generate candidate actions (or trajectories) to such parking spaces. In such cases, the vehicle may generate one or more candidate actions to one or more parking spaces. For example, box 120 illustrates a candidate action 124 leading the vehicle 122 to parking space 126. As shown, the parking space 126 may be a curbside parking space and may correspond to the first parking space from box 116.

At operation 128, the vehicle may be controlled based on the candidate action(s). Based on generating the candidate action 124, the vehicle may evaluate the candidate action 124 (e.g., input the candidate action into a tree structure) and determine a control trajectory that may be a combination of one or more candidate actions. In this case, box 130 illustrates the vehicle 122 parked in the parking space 126. As such, in this case, the vehicle may determine, based on evaluating the candidate action 124, to navigate to and/or pickup the passenger in the parking space 126.

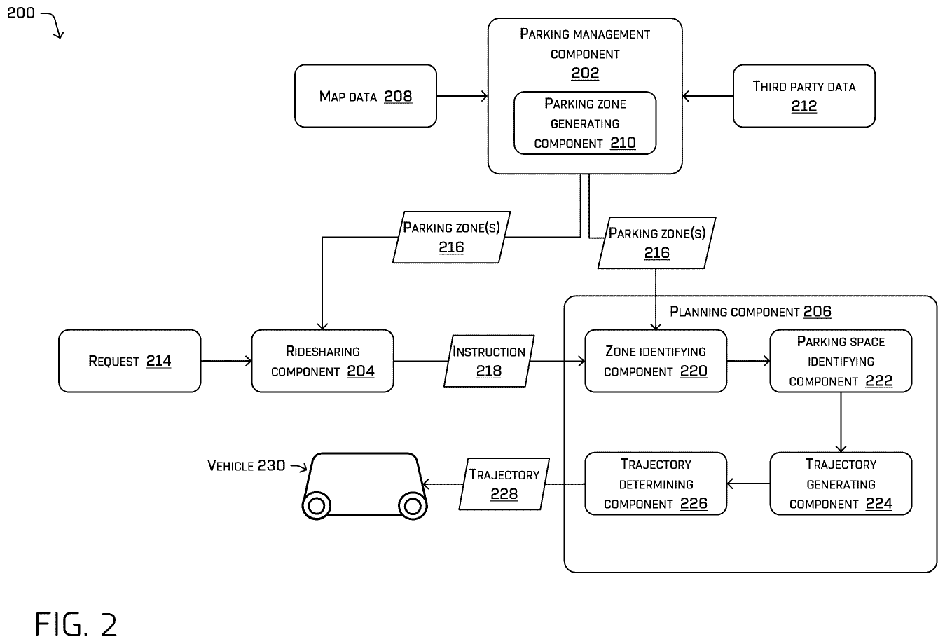

FIG. 2 illustrates an example computing system 200 including a parking management component 202 configured to generate parking zones, a ridesharing component 204 configured to use the parking zones to facilitate the requesting of a ride, and/or a planning component 206 configured to use the parking zones when picking up and/or dropping off passengers.

In some examples, the parking management component 202 may receive map data 208. In some examples, the parking management component 202 may receive the map data 208 from an external map server, and/or may store the map data 208 in an internal storage. For instance, the autonomous vehicle may request a receive map data 208 from a remote map server and store one or more maps locally on the vehicle. In some examples, map data 208 can include any number of data structures, modeled in two or more dimensions that are capable of providing information about the environment, such as, but not limited to, road network data, topologies, intersections (or junctions), streets, roads (or driving lanes), terrain, and the environment in general. The map data 208 may also represent various map features within the environment along the route, including but not limited to roads, lanes, curbs, shoulders, crosswalks, buildings, medians, street signs, traffic signs, speed limits, etc. In some examples, the map data 208 may be sent to the parking zone generating component 210 within the parking management component 202.

Additionally, the parking management component 202 may receive third party data 212. Third parties may include cities, hotels, airports, etc. Further, such third parties may provide data associated with where and/or how vehicles may pick up and/or drop off passengers within areas associated with such third parties.

In some examples, the parking management component 202 may be configured to generate and/or use parking zones. The parking management component 202 may receive the map data 208 and the third party data 212. The parking management component 202 may include one or more subcomponents that include the parking zone generating component 210. In some examples, the parking zone generating component 210 may use the map data and the third party data to generate the parking zones. As described above, the parking zones may span one or more road segments, driving lanes, and/or lane segments that follow the same direction of travel and/or do not block or overlap with emergency objects (e.g., fire hydrants, red curbs, etc.). In some cases, the data received from the map data 208 and/or the third parties may include one or more parameters that indicate when such parking zones may be available. For example, the parameters may include weather data (e.g., certain parking zones may be unavailable based on weather conditions), environmental restrictions (e.g., city restrictions), safety data (e.g., certain parking zones may be unavailable due to the level of safety associated with parking in the parking zone being below a threshold value), time of day data (e.g., certain parking zones may be available or unavailable based on the time of day). The parking management component 202 may send the parking zones 216 to the ridesharing component 204 and/or to the planning component 206.

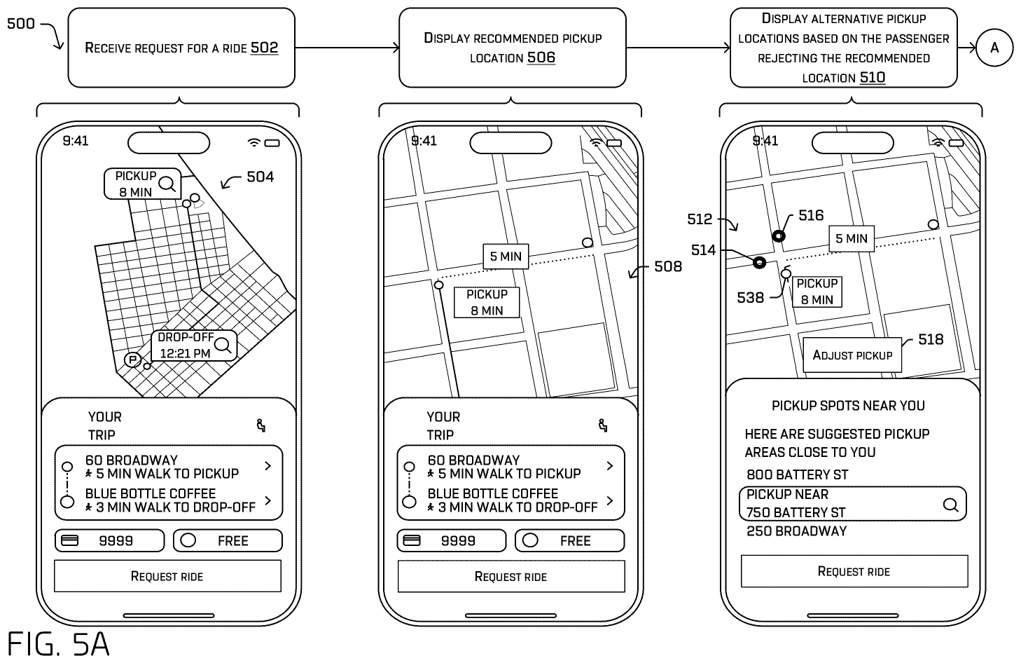

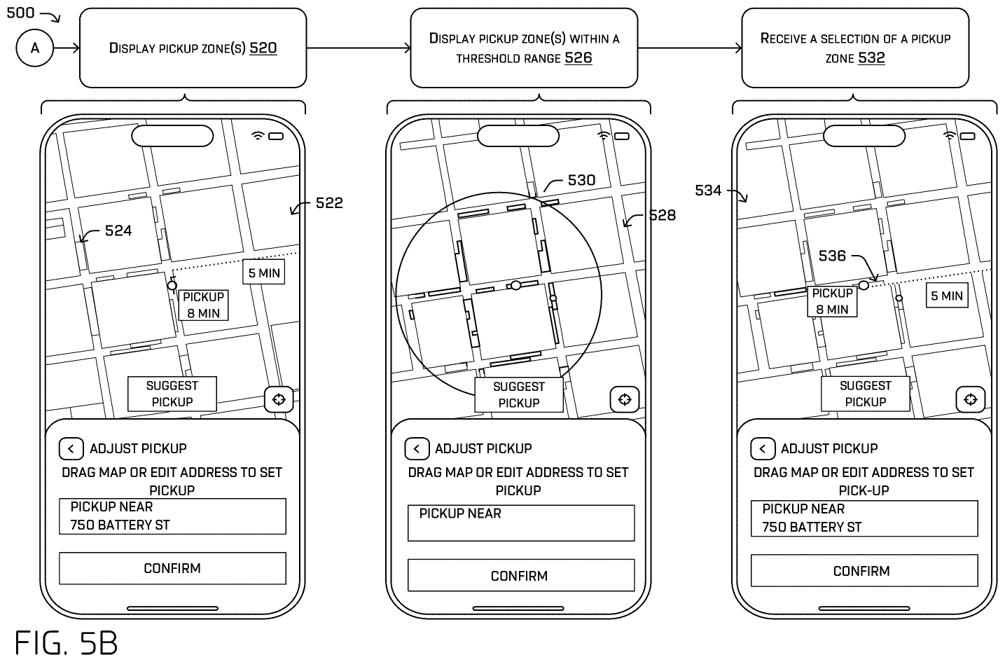

In some examples, the ridesharing component 204 may receive a request 214 from a user device. That is, a potential passenger may use a user device (e.g., stationary, mobile, etc.) to request a ride from a vehicle. In such cases, the potential passenger may use the user device to access a ridesharing application or platform that facilitates the requesting of rides. In this example, the ridesharing component 204 may receive a request from the potential passenger. The request may include a requested starting and ending location. In such examples, and as described in FIGS. 5A and 5B, the ridesharing component 204 may analyze the request, determine recommended pickup locations based on the parking zones 216, and/or cause the parking zones 216 (or a subset of the parking zones based on the parking zone parameters) to be displayed to a user interface such that the potential passenger may select where to be picked up from such parking zones 216. Based on receiving confirmation from the potential passenger, the ridesharing component 204 may send an instruction 218 to a planning component 206.

In some examples, the planning component 206 may be configured to generate vehicle actions to pickup the potential passenger. The planning component 206 may receive the instruction 218 and the parking zone(s) 216. As shown, the planning component 206 may include a zone identifying component 220 configured to identify a parking zone to navigate to, a parking space identifying component 222 configured to identify a subset of candidate parking spaces, a trajectory generating component 224 configured to generate candidate actions (or trajectories), and/or a trajectory determining component 226 configured to generate a control trajectory 228 for the vehicle to follow.

In some examples, the zone identifying component 220 configured to identify a parking zone to navigate to. The zone identifying component 220 may receive the instruction 218 and/or the parking zones 216. In such cases, the zone identifying component 220 may determine whether the instruction 218 includes the parking zone. If the instruction 218 includes the parking zone, a vehicle component may cause the vehicle 230 to navigate to the parking zone. If the instruction 218 lacks the parking zone, the zone identifying component 220 may determine within which parking zone 216 the destination location is located. Upon identifying the parking zone, the vehicle may navigate to the parking zone.

In some examples, the parking space identifying component 222 configured to identify a subset of candidate parking spaces. The parking space identifying component 222 may retrieve the map data 208 (not shown) and identify the one or more parking spaces that are located within the parking zone 216. That is, the parking zone 216 may encompass one or more parking spaces and the parking space identifying component 222 may identify such parking spaces. Further, the parking space identifying component 222 may determine a subset of these parking spaces by filtering the parking spaces based on which parking spaces satisfy the parameters of the parking zone 216. That is, as an example, the parking zone 216 may indicate that allowable parking maneuvers are parallel parking and/or curbside parking. As such, the parking space identifying component 222 may filter out (or remove from the list of available parking spaces) parking spaces that are not parallel parking or curbside parking. Upon determining the subset of parking spaces, the parking space identifying component 222 may send the subset to the trajectory generating component 224.

In some examples, the trajectory generating component 224 configured to generate candidate actions (or trajectories) to the subset of parking spaces. The trajectory generating component 224 may receive the subset of parking spaces and generate candidate actions to such parking spaces. Examples of various techniques for generating planner trajectories for autonomous vehicles can be found, for example, in U.S. Pat. No. 10,921,811, filed on Jan. 22, 2018, issued on Feb. 16, 2021, and titled, “Adaptive Autonomous Vehicle Planner Logic,” and U.S. Pat. No. 10,955,851, filed on Feb. 14, 2018, issued on Mar. 23, 2021, and titled, “Detecting Blocking Objects,” each of which is incorporated by reference herein in its entirety.

In some examples, the trajectory determining component 226 configured to generate a control trajectory 228 for the vehicle to follow. The trajectory determining component 226 may be configured to generate a tree structure including the candidate trajectories and determine costs associated with such trajectories. The trajectory determining component 226 may receive the candidate trajectories from the trajectory generating component 224. In some examples, the trajectory determining component 226 may generate a tree structure that includes some or all of the candidate trajectories. The purpose of the tree structure is to enable the vehicle to evaluate the candidate trajectories at each state of the vehicle and to determine a control trajectory for the vehicle to follow based on such candidate trajectories. The tree structure may include an initial node (e.g., root node) which represents the state of the vehicle. Multiple candidate trajectories may extend from the initial node. In such instances, the trajectory determining component 226 may determine a traversal path based on the candidate trajectories that results in the traversal path having a lowest determined overall cost.

Further, the trajectory determining component 226 may determine or otherwise select a candidate trajectory to follow. In such instances, the trajectory determining component 226 may determine an overall cost based on combining the sub-costs (e.g., parking cost, progress cost, lane ending cost, lane blocking cost, and/or any other cost) into a single overall cost. The vehicle may determine to follow a control trajectory that has the lowest overall cost compared to the overall costs of the other potential traversal paths between the candidate trajectories. The trajectory determining component 226 may send the trajectory 228 to the vehicle 230 for the vehicle 230 to follow. In such instances, upon receiving the trajectory 228, the vehicle 230 may be controlled, based on the instructions included in the trajectory 228, to follow the trajectory 228 throughout the environment.

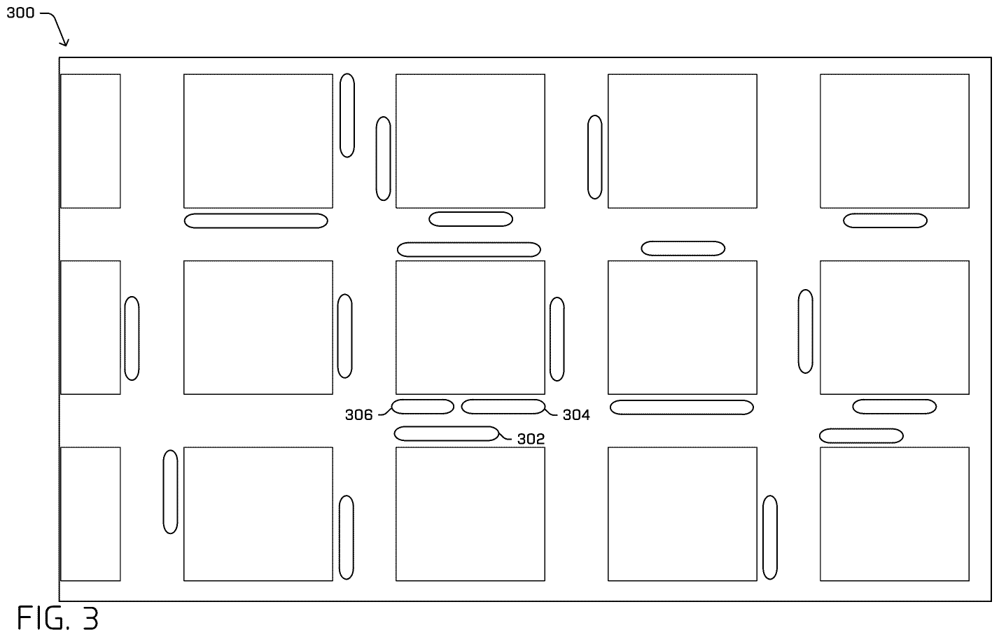

FIG. 3 is an example environment 300 that illustrates example parking zones spanning various regions of a driving environment.

In this example, the example environment 300 may include one or more driving roads and/or one or more junctions. The example environment 300 may be a region of the environment in which passenger(s) may request to be picked up and/or dropped off. As such, a vehicle may use one or more parking zones to facilitate the pick up and/or drop off process.

As shown, the example environment 300 may include parking zones. That is, prior to displaying such parking zones, the system may identify the available parking zones based on one or more parameters (e.g., weather, convenience, time of day, safety (or level of safety), etc.). Based on identifying the available parking zones, the system may cause the parking zones to be displayed to a user device and/or be updated in a database accessible to a fleet of vehicles. In this example, the example environment 300 may include the parking zone 302, the parking zone 304, and/or the parking zone 306. The parking zone 302 may cover a different region of the example environment 300 than the parking zone 304. That is, the parking zone 302 may encompass one or more parking spaces on a first side of a road along a first direction of travel while the parking zone 304 may encompass one or more parking spaces on a second side of the road alone a second direction of travel. The parking zone 306 may be associated with a same curb and/or side of the road as the parking zone 304. There may be multiple parking zones on the same side of the road based on restricted areas to park (e.g., time of day restrictions, presence of driveways, presence of emergency buildings, etc.). As noted above, the parking zones may include one or more parameters which describe the characteristics of parking within the parking zone. Such parameters may be received from map data and/or a third party.

In some examples, when picking up a passenger, the vehicle may use the parking zones by identifying the parking zone to pick up the passenger. Based on identifying the pickup zone, the vehicle may obtain (e.g., receive, identify, generate, etc.) the parking spaces within the parking zone and filter through the parking spaces to identify the parking spaces that conform to the parameters of the parking zone. Based on identifying conforming parking spaces, the vehicle may generate candidate actions that lead to some or all of the parking spaces be controlled based on a combination of such candidate actions.

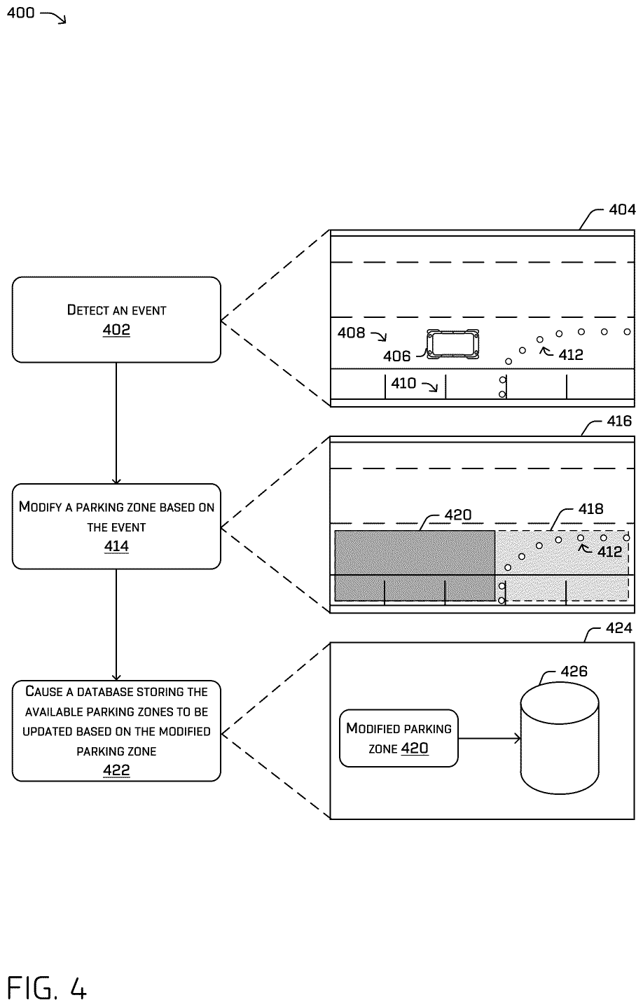

FIG. 4 is a pictorial flow diagram illustrating an example process 400 for updating parking zones stored in a database accessible to a fleet of vehicles.

At operation 402, the vehicle may identify an event. In some examples, a vehicle may capture sensor data while navigating an environment. The vehicle may analyze the sensor data to detect objects, events (e.g., emergency, construction, etc.), etc. For example, box 404 illustrates a driving lane at least partially blocked by construction cones. In this example, the box 404 may a vehicle 406 navigating in a driving lane 408. include a driving lane 408. Further, the box 404 may include one or more parking spaces 410 located laterally adjacent to the driving lane 408. The parking spaces 410 may be curbside parking; however, in other examples, the parking spaces 410 may be any other type of parking.

As shown, box 404 may also include multiple construction cones 412 located within the driving lane 408. In this example, the vehicle 406 may receive sensor data and detect the construction cones 412. Accordingly, the vehicle 406 may determine that the driving lane 408 includes a construction zone (or event).

At operation 414, the vehicle may modify a parking zone based on the event. That is, the vehicle 406 may include one or more parking zones that span regions of the environment and that may be used to increase parking flexibility and/or the ability to conform to rules of the road and/or environmental expectations. The parking zones may include predefined dimensions that encompass one or more parking spaces. However, based on detecting the event, the vehicle 406 may identify the parking zone associated with the event, determining a subset of the parking zone is not associated with the event, and/or modifying the parking zone accordingly. That is, the vehicle may modify the dimensions of the parking zone such that the portion of the original parking zone that overlaps with the event may be removed from the list of available parking zones while the portion of the original parking zone that does not overlap with the event may remain available to vehicles. For example, box 416 illustrates the dimensions of a parking zone being modified. In this example, the vehicle may determine that the original parking zone 418 overlaps with the event (or construction cones 412). In such cases, the vehicle 406 may modify the dimensions of the original parking zone 418 such that the portion of the original parking zone 418 that overlaps with the event is no longer indicative of available parking. As such, the vehicle may generate a modified parking zone 420 that is a modified version of the original parking zone 418.

At operation 422, the vehicle may cause a database storing the available parking zones to be updated based on the modified parking zone 420. That is, based on modifying the parking zone, the vehicle may update the database. For example, box 424 illustrates transmitting the modified parking zone 420 to the database 426 such that the database 426 includes an accurate representation of the available parking zones. That is, the vehicle may send the updated dimensions and/or availability of the modified parking zone 420 to the database 426. Updating the database 426 may enable other vehicles in the fleet to know that the parking zone associated with the event is unavailable but that the modified parking zone 420 is available.

FIGS. 5A and 5B are a pictorial flow diagram illustrating an example process 500 for requesting a ride via a user device based on the parking zones. As described above, some or all operations in the example process 500 may be performed by a ridesharing component that is similar or identical to the ridesharing component 204 as described throughout.

FIG. 5A illustrates the ridesharing component displaying recommended pickup locations in response to receiving a request for a ride.

At operation 502, the ridesharing component may receive a request for a ride. A potential passenger may use a user device (e.g., mobile device, stationary device, etc.) to access a ridesharing application. In such cases, the ridesharing application may include a ride requesting user interface with which the passenger may interact to request a ride from a vehicle. That is, the passenger may use the ridesharing application to request a ride from a vehicle. For example, user interface 504 may illustrate a pickup and drop off location as requested by the passenger. In this example, the passenger may be requesting to be picked up at “60 Broadway” and get dropped off at “Blue Bottle Coffee.” In such cases, the passenger may submit the request to the ridesharing application. That is, the ridesharing application may receive the request from the passenger.

At operation 506, the ridesharing component may display a recommended pickup location. Based on receiving the request at operation 502, the ridesharing component may determine and/or display a recommended pickup location based on available parking spaces proximate the requested pickup location (e.g., “60 Broadway”). The ridesharing component may determine the recommended pickup location by obtaining parking zones from a database and determining (or identifying) a parking zone closest to (or within a threshold distance from) the requested pickup location. In such cases, the ridesharing component may display the recommended pickup location to the user device. For example, user interface 508 illustrates a recommended pickup location. In this example, the recommended pickup location may be a five minute walk from where the passenger is located. In such cases, the passenger may determine whether to accept or reject the recommended pickup location.

At operation 510, the ridesharing component may display alternative pickup locations based on the passenger rejecting the recommended location. In some examples, the passenger may determine that the recommended pickup location is suboptimal and may reject the recommended pickup location. In such cases, the ridesharing application may identify alternative pickup locations that are proximate the requested pickup location. For example, the ride sharing application may retrieve the parking zones from the database and identify additional parking zones proximate the requested pickup location and cause parking locations associated therewith to be displayed via the user interface. For example, user interface 512 may illustrate multiple alternative pickup locations. That is, the passenger may reject the recommended parking location 538, and as such, the ridesharing application may identify alternative location(s). In this example, the user interface 512 may include an alternative pickup location 514 and an alternative pickup location 516. In such cases, if the passenger determines that such alternative pickup locations are suboptimal, the passenger may select the button 518 (e.g., “adjust pickup”). Selecting the button 518 may cause the ridesharing application to display one or more parking zones.

FIG. 5B illustrates the ridesharing component displaying parking zones from which the passenger can be picked up.

At operation 520, the ridesharing component may display pickup zone(s). Based on the passenger rejecting the alternative pickup location(s) as shown in user interface 512, the rideshare application may provide additional pickup options by displaying the parking zones. For example, the ridesharing application may retrieve the parking zones from the database and cause the parking zones to be displayed via the user device. When determining a subset of the parking zones to display, the ridesharing component may analyze the parameters (e.g., weather, safety, time of day, etc.) of the parking zones. In such cases, the ridesharing application may display the subset of parking zones that are listed as available. As shown, user interface 522 may illustrate one or more parking zones 524 from which the passenger may select. The parking zones 524 may span a portions of the environment. In this example, the parking zones 524 may encompass one or more parking spaces within the environment. The passenger may select one of the parking zones which may represent the region (or area) of the environment that the vehicle will pick up the passenger.

At operation 526, the ridesharing component may display pickup zone(s) within a threshold range of the passenger. In some cases, it may be beneficial to display which parking zones are within a threshold range of the passenger such that the passenger knows how far such parking zones are. For example, the passenger may indicate that they want to view all parking zones within 90 meters of the passenger, all parking zones within a 10 minute walk, etc. As such, user interface 528 illustrates a threshold that highlights the parking zones encompassed therein. In this example, the threshold 530 may be a circle that illustrates to the passenger a certain distance from the passenger position, a certain walk time from the passenger position, etc.

At operation 532, the ridesharing component may receive a selection of a pickup zone. Based on displaying the parking zones, the passenger may select (or determine) one of the parking zones at which to be picked up. For example, user interface 534 illustrates the passenger selecting parking zone 536. Based on the passenger selecting the parking zone 536, the ridesharing application may send the request and/or the parking zone to a vehicle. In such cases, the request and the parking zone sent to the vehicle may provide guidance to the vehicle to determine a parking location to pickup the passenger. In some cases, the ridesharing application may modify the user interface element (or object) that represents the parking zone. That is, the ridesharing application may highlight a portion of the parking zone that is most likely for the vehicle to pickup the passenger. The ridesharing application or the vehicle may determine the likelihood data based on identifying already occupied parking spaces within a parking zone, historical data (e.g., where the vehicle has historically picked up passengers (or users) within the parking zone), safety, a location of the passenger within the parking zone, etc. Based on identifying the likelihood data, the ridesharing application may modify the user interface element such that the passenger is able to identify a likely location for the vehicle to pick them up at.

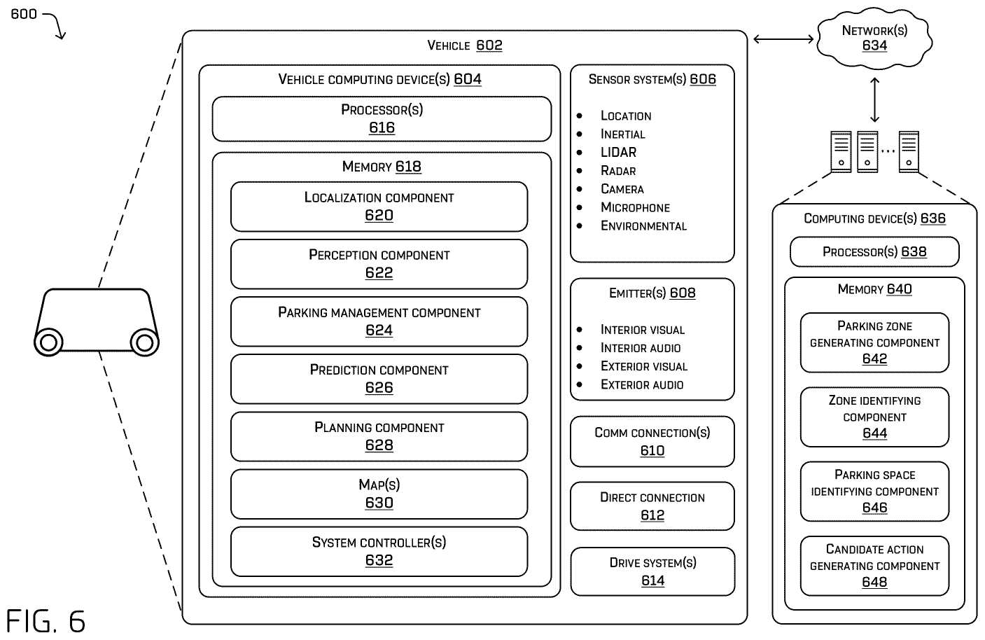

FIG. 6 is a block diagram of an example system 600 for implementing the techniques described herein. In at least one example, the system 600 may include a vehicle, such as vehicle 602. The vehicle 602 may include one or more vehicle computing devices 604, one or more sensor systems 606, one or more emitters 608, one or more communication connections 610, at least one direct connection 612, and one or more drive systems 614.

The vehicle computing device 604 may include one or more processors 616 and memory 618 communicatively coupled with the processor(s) 616. In the illustrated example, the vehicle 602 is an autonomous vehicle; however, the vehicle 602 could be any other type of vehicle, such as a semi-autonomous vehicle, or any other system having at least an image capture device (e.g., a camera-enabled smartphone). In some instances, the autonomous vehicle 602 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the autonomous vehicle 602 may be a fully or partially autonomous vehicle having any other level or classification.

In the illustrated example, the memory 618 of the vehicle computing device 604 stores a localization component 620, a perception component 622, a parking generating component 624, a prediction component 626, a planner component 628, one or more system controllers 632, and one or more maps 630 (or map data). Though depicted in FIG. 6 as residing in the memory 618 for illustrative purposes, it is contemplated that the localization component 620, the perception component 622, the parking generating component 624, the prediction component 626, the planner component 628, system controller(s) 632, and/or the map(s) may additionally, or alternatively, be accessible to the vehicle 602 (e.g., stored on, or otherwise accessible by, memory remote from the vehicle 602, such as, for example, on memory 640 of one or more computing device 636 (e.g., a remote computing device)). In some examples, the memory 640 may include a parking zone generating component 642, a zone identifying component 644, a parking space identifying component 646, and/or a candidate action generating component 648.

In at least one example, the localization component 620 may include functionality to receive sensor data from the sensor system(s) 606 to determine a position and/or orientation of the vehicle 602 (e.g., one or more of an x-, y-, z-position, roll, pitch, or yaw). For example, the localization component 620 may include and/or request/receive a map of an environment, such as from map(s) 630, and may continuously determine a location and/or orientation of the vehicle 602 within the environment. In some instances, the localization component 620 may utilize SLAM (simultaneous localization and mapping), CLAMS (calibration, localization and mapping, simultaneously), relative SLAM, bundle adjustment, non-linear least squares optimization, or the like to receive image data, lidar data, radar data, inertial measurement unit (IMU) data, GPS data, wheel encoder data, and the like to accurately determine a location of the vehicle 602. In some instances, the localization component 620 may provide data to various components of the vehicle 602 to determine an initial position of the vehicle 602 for determining the relevance of an object to the vehicle 602, as discussed herein.

In some instances, the perception component 622 may include functionality to perform object detection, segmentation, and/or classification. In some examples, the perception component 622 may provide processed sensor data that indicates a presence of an object (e.g., entity) that is proximate to the vehicle 602 and/or a classification of the object as an object type (e.g., car, pedestrian, cyclist, animal, building, tree, road surface, curb, sidewalk, unknown, etc.). In some examples, the perception component 622 may provide processed sensor data that indicates a presence of a stationary entity that is proximate to the vehicle 602 and/or a classification of the stationary entity as a type (e.g., building, tree, road surface, curb, sidewalk, unknown, etc.). In additional or alternative examples, the perception component 622 may provide processed sensor data that indicates one or more features associated with a detected object (e.g., a tracked object) and/or the environment in which the object is positioned. In some examples, features associated with an object may include, but are not limited to, an x-position (global and/or local position), a y-position (global and/or local position), a z-position (global and/or local position), an orientation (e.g., a roll, pitch, yaw), an object type (e.g., a classification), a velocity of the object, an acceleration of the object, an extent of the object (size), etc. Features associated with the environment may include, but are not limited to, a presence of another object in the environment, a state of another object in the environment, a time of day, a day of a week, a season, a weather condition, an indication of darkness/light, etc.

The prediction component 626 may generate one or more probability maps representing prediction probabilities of possible locations of one or more objects in an environment. For example, the prediction component 626 may generate one or more probability maps for vehicles, pedestrians, animals, and the like within a threshold distance from the vehicle 602. In some instances, the prediction component 626 may measure a track of an object and generate a discretized prediction probability map, a heat map, a probability distribution, a discretized probability distribution, and/or a trajectory for the object based on observed and predicted behavior. In some instances, the one or more probability maps may represent an intent of the one or more objects in the environment.

In some examples, the prediction component 626 may generate predicted trajectories of objects (e.g., objects) in an environment. For example, the prediction component 626 may generate one or more predicted trajectories for objects within a threshold distance from the vehicle 602. In some examples, the prediction component 626 may measure a trace of an object and generate a trajectory for the object based on observed and predicted behavior. Additionally, the prediction component 626 may be perform any of the techniques described with respect to any of FIGS. 1-6 above with respect to receiving, retrieving, determining, and/or generating predicted trajectories for object(s) within the environment.

In general, the planner component 628 may determine a path for the vehicle 602 to follow to traverse through an environment. For example, the planner component 628 may determine various routes and trajectories and various levels of detail. For example, the planner component 628 may determine a route to travel from a first location (e.g., a current location) to a second location (e.g., a target location). For the purpose of this discussion, a route may include a sequence of waypoints for travelling between two locations. As non-limiting examples, waypoints include streets, intersections, global positioning system (GPS) coordinates, etc. Further, the planner component 628 may generate an instruction for guiding the vehicle 602 along at least a portion of the route from the first location to the second location. In at least one example, the planner component 628 may determine how to guide the vehicle 602 from a first waypoint in the sequence of waypoints to a second waypoint in the sequence of waypoints. In some examples, the instruction may be a candidate trajectory, or a portion of a trajectory. In some examples, multiple trajectories may be substantially simultaneously generated (e.g., within technical tolerances) in accordance with a receding horizon technique. A single path of the multiple paths in a receding data horizon having the highest confidence level may be selected to operate the vehicle. In various examples, the planner component 628 may select a trajectory for the vehicle 602.

In other examples, the planner component 628 may alternatively, or additionally, use data from the localization component 620, the perception component 622, and/or the prediction component 626 to determine a path for the vehicle 602 to follow to traverse through an environment. For example, the planner component 628 may receive data (e.g., object data) from the localization component 620, the perception component 622, and/or the prediction component 626 regarding objects associated with an environment. In some examples, the planner component 628 receives data for relevant objects within the environment. Using this data, the planner component 628 may determine a route to travel from a first location (e.g., a current location) to a second location (e.g., a target location) to avoid objects in an environment. In at least some examples, such a planner component 628 may determine there is no such collision-free path and, in turn, provide a path that brings vehicle 602 to a safe stop avoiding all collisions and/or otherwise mitigating damage.

The parking generating component 624 may perform any of the techniques described with respect to any of FIGS. 1-5B above with respect to generating and/or utilizing parking zones when performing pickup and/or drop off maneuvers.

In at least one example, the vehicle computing device 604 may include one or more system controllers 632, which may be configured to control steering, propulsion, braking, safety, emitters, communication, and other systems of the vehicle 602. The system controller(s) 632 may communicate with and/or control corresponding systems of the drive system(s) 614 and/or other components of the vehicle 602.

The memory 618 may further include one or more maps 630 that may be used by the vehicle 602 to navigate within the environment. For the purpose of this discussion, a map may be any number of data structures modeled in two dimensions, three dimensions, or N-dimensions that are capable of providing information about an environment, such as, but not limited to, topologies (such as intersections), streets, mountain ranges, roads, terrain, and the environment in general. In some instances, a map may include, but is not limited to: texture information (e.g., color information (e.g., RGB color information, Lab color information, HSV/HSL color information), and the like), intensity information (e.g., lidar information, radar information, and the like); spatial information (e.g., image data projected onto a mesh, individual “surfels” (e.g., polygons associated with individual color and/or intensity)), reflectivity information (e.g., specularity information, retroreflectivity information, BRDF information, BSSRDF information, and the like). In one example, a map may include a three-dimensional mesh of the environment. In some examples, the vehicle 602 may be controlled based at least in part on the map(s) 630. That is, the map(s) 630 may be used in connection with the localization component 620, the perception component 622, the prediction component 626, and/or the planner component 628 to determine a location of the vehicle 602, detect objects in an environment, generate routes, determine actions and/or trajectories to navigate within an environment.

In some examples, the one or more maps 630 may be stored on a remote computing device(s) (such as the computing device(s) 636) accessible via network(s) 634. In some examples, multiple maps 630 may be stored based on, for example, a characteristic (e.g., type of entity, time of day, day of week, season of the year, etc.). Storing multiple maps 630 may have similar memory requirements, but increase the speed at which data in a map may be accessed.

In some instances, aspects of some or all of the components discussed herein may include any models, techniques, and/or machine-learned techniques. For example, in some instances, the components in the memory 618 (and the memory 640, discussed below) may be implemented as a neural network.

As described herein, an exemplary neural network is a technique which passes input data through a series of connected layers to produce an output. Each layer in a neural network may also comprise another neural network, or may comprise any number of layers (whether convolutional or not). As may be understood in the context of this disclosure, a neural network may utilize machine learning, which may refer to a broad class of such techniques in which an output is generated based on learned parameters.

Although discussed in the context of neural networks, any type of machine learning may be used consistent with this disclosure. For example, machine learning techniques may include, but are not limited to, regression techniques (e.g., ordinary least squares regression (OLSR), linear regression, logistic regression, stepwise regression, multivariate adaptive regression splines (MARS), locally estimated scatterplot smoothing (LOESS)), instance-based techniques (e.g., ridge regression, least absolute shrinkage and selection operator (LASSO), elastic net, least-angle regression (LARS)), decisions tree techniques (e.g., classification and regression tree (CART), iterative dichotomiser 3 (ID3), Chi-squared automatic interaction detection (CHAID), decision stump, conditional decision trees), Bayesian techniques (e.g., naïve Bayes, Gaussian naïve Bayes, multinomial naïve Bayes, average one-dependence estimators (AODE), Bayesian belief network (BNN), Bayesian networks), clustering techniques (e.g., k-means, k-medians, expectation maximization (EM), hierarchical clustering), association rule learning techniques (e.g., perceptron, back-propagation, hopfield network, Radial Basis Function Network (RBFN)), deep learning techniques (e.g., Deep Boltzmann Machine (DBM), Deep Belief Networks (DBN), Convolutional Neural Network (CNN), Stacked Auto-Encoders), Dimensionality Reduction Techniques (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Techniques (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc.

Additional examples of architectures include neural networks such as ResNet-50, ResNet-101, VGG, DenseNet, PointNet, Xception, ConvNeXt, and the like; visual transformer(s) (ViT(s)), such as a bidirectional encoder from image transformers (BEiT), visual bidirectional encoder from transformers (VisualBERT), image generative pre-trained transformer (Image GPT), data-efficient image transformers (DeiT), deeper vision transformer (DeepViT), convolutional vision transformer (CvT), detection transformer (DETR), Miti-DETR, or the like; and/or general or natural language processing transformers, such as BERT, GPT, GPT-2, GPT-3, or the like. In some examples, the ML model discussed herein may comprise PointPillars, SECOND, top-down feature layers (e.g., see U.S. patent application Ser. No. 15/963,833 , which is incorporated by reference in its entirety herein for all purposes), and/or VoxelNet. Architecture latency optimizations may include MobilenetV2, Shufflenet, Channelnet, Peleenet, and/or the like. The ML model may comprise a residual block such as Pixor, in some examples.

In at least one example, the sensor system(s) 606 may include lidar sensors, radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), cameras (e.g., RGB, IR, intensity, depth, time of flight, etc.), microphones, wheel encoders, environment sensors (e.g., temperature sensors, humidity sensors, light sensors, pressure sensors, etc.), etc. The sensor system(s) 606 may include multiple instances of each of these or other types of sensors. For instance, the lidar sensors may include individual lidar sensors located at the corners, front, back, sides, and/or top of the vehicle 602. As another example, the camera sensors may include multiple cameras disposed at various locations about the exterior and/or interior of the vehicle 602. The sensor system(s) 606 may provide input to the vehicle computing device 604. Additionally, or in the alternative, the sensor system(s) 606 may send sensor data, via the one or more networks 634, to the one or more computing device(s) 636 at a particular frequency, after a lapse of a predetermined period of time, in near real-time, etc.

The vehicle 602 may also include one or more emitters 608 for emitting light and/or sound. The emitter(s) 608 may include interior audio and visual emitters to communicate with passengers of the vehicle 602. By way of example and not limitation, interior emitters may include speakers, lights, signs, display screens, touch screens, haptic emitters (e.g., vibration and/or force feedback), mechanical actuators (e.g., seatbelt tensioners, seat positioners, headrest positioners, etc.), and the like. The emitter(s) 608 may also include exterior emitters. By way of example and not limitation, the exterior emitters may include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology.

The vehicle 602 may also include one or more communication connections 610 that enable communication between the vehicle 602 and one or more other local or remote computing device(s). For instance, the communication connection(s) 610 may facilitate communication with other local computing device(s) on the vehicle 602 and/or the drive system(s) 614. Also, the communication connection(s) 610 may allow the vehicle to communicate with other nearby computing device(s) (e.g., computing device 636, other nearby vehicles, etc.) and/or one or more remote sensor system(s) for receiving sensor data. The communications connection(s) 610 also enable the vehicle 602 to communicate with a remote teleoperations computing device or other remote services.

The communications connection(s) 610 may include physical and/or logical interfaces for connecting the vehicle computing device 604 to another computing device or a network, such as network(s) 634. For example, the communications connection(s) 610 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.) or any suitable wired or wireless communications protocol that enables the respective computing device to interface with the other computing device(s).

In at least one example, the vehicle 602 may include one or more drive systems 614. In some examples, the vehicle 602 may have a single drive system 614. In at least one example, if the vehicle 602 has multiple drive systems 614, individual drive systems 614 may be positioned on opposite ends of the vehicle 602 (e.g., the front and the rear, etc.). In at least one example, the drive system(s) 614 may include one or more sensor systems to detect conditions of the drive system(s) 614 and/or the surroundings of the vehicle 602. By way of example and not limitation, the sensor system(s) may include one or more wheel encoders (e.g., rotary encoders) to sense rotation of the wheels of the drive modules, inertial sensors (e.g., inertial measurement units, accelerometers, gyroscopes, magnetometers, etc.) to measure orientation and acceleration of the drive module, cameras or other image sensors, ultrasonic sensors to acoustically detect objects in the surroundings of the drive module, lidar sensors, radar sensors, etc. Some sensors, such as the wheel encoders may be unique to the drive system(s) 614. In some cases, the sensor system(s) on the drive system(s) 614 may overlap or supplement corresponding systems of the vehicle 602 (e.g., sensor system(s) 606).

The drive system(s) 614 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 614 may include a drive module controller which may receive and preprocess data from the sensor system(s) and to control operation of the various vehicle systems. In some examples, the drive module controller may include one or more processors and memory communicatively coupled with the one or more processors. The memory may store one or more modules to perform various functionalities of the drive system(s) 614. Furthermore, the drive system(s) 614 may also include one or more communication connection(s) that enable communication by the respective drive module with one or more other local or remote computing device(s).

In at least one example, the direct connection 612 may provide a physical interface to couple the one or more drive system(s) 614 with the body of the vehicle 602. For example, the direct connection 612 may allow the transfer of energy, fluids, air, data, etc. between the drive system(s) 614 and the vehicle. In some instances, the direct connection 612 may further releasably secure the drive system(s) 614 to the body of the vehicle 602.

In at least one example, the localization component 620, the perception component 622, the parking generating component 624, the prediction component 626, the planner component 628, the one or more system controllers 632, and the one or more maps 630 may process sensor data, as described above, and may send their respective outputs, over the one or more network(s) 634, to the computing device(s) 636. In at least one example, the localization component 620, the perception component 622, the parking generating component 624, the prediction component 626, the planner component 628, the one or more system controllers 632, and the one or more maps 630 may send their respective outputs to the computing device(s) 636 at a particular frequency, after a lapse of a predetermined period of time, in near real-time, etc.

In some examples, the vehicle 602 may send sensor data to the computing device(s) 636 via the network(s) 634. In some examples, the vehicle 602 may receive sensor data from the computing device(s) 636 and/or remote sensor system(s) via the network(s) 634. The sensor data may include raw sensor data and/or processed sensor data and/or representations of sensor data. In some examples, the sensor data (raw or processed) may be sent and/or received as one or more log files.

The computing device(s) 636 may include processor(s) 638 and a memory 640, which may include a parking zone generating component 642, a zone identifying component 644, a parking space identifying component 646, and/or a candidate action generating component 648. In some examples, the memory 640 may store one or more of components that are similar to the component(s) stored in the memory 618 of the vehicle 602. In such examples, the computing device(s) 636 may be configured to perform one or more of the processes described herein with respect to the vehicle 602. In some examples, the parking zone generating component 642, the zone identifying component 644, the parking space identifying component 646, and/or the candidate action generating component 648 may perform substantially similar functions as the parking generating component 624, a ride sharing application, and/or the planning component 628.

The processor(s) 616 of the vehicle 602 and the processor(s) 638 of the computing device(s) 636 may be any suitable processor capable of executing instructions to process data and perform operations as described herein. By way of example and not limitation, the processor(s) may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

Memory 618 and memory 640 are examples of non-transitory computer-readable media. The memory 618 and memory 640 may store an operating system and one or more software applications, instructions, programs, and/or data to implement the methods described herein and the functions attributed to the various systems. In various implementations, the memory may be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

It should be noted that while FIG. 6 is illustrated as a distributed system, in alternative examples, components of the vehicle 602 may be associated with the computing device(s) 636 and/or components of the computing device(s) 636 may be associated with the vehicle 602. That is, the vehicle 602 may perform one or more of the functions associated with the computing device(s) 636, and vice versa.

The methods described herein represent sequences of operations that may be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be combined in any order and/or in parallel to implement the processes. In some examples, one or more operations of the method may be omitted entirely. For instance, the operations may include determining a first action and a second action by the vehicle relative to a selected trajectory without determining a respective cost for one or more of the actions by the vehicle. Moreover, the methods described herein may be combined in whole or in part with each other or with other methods.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

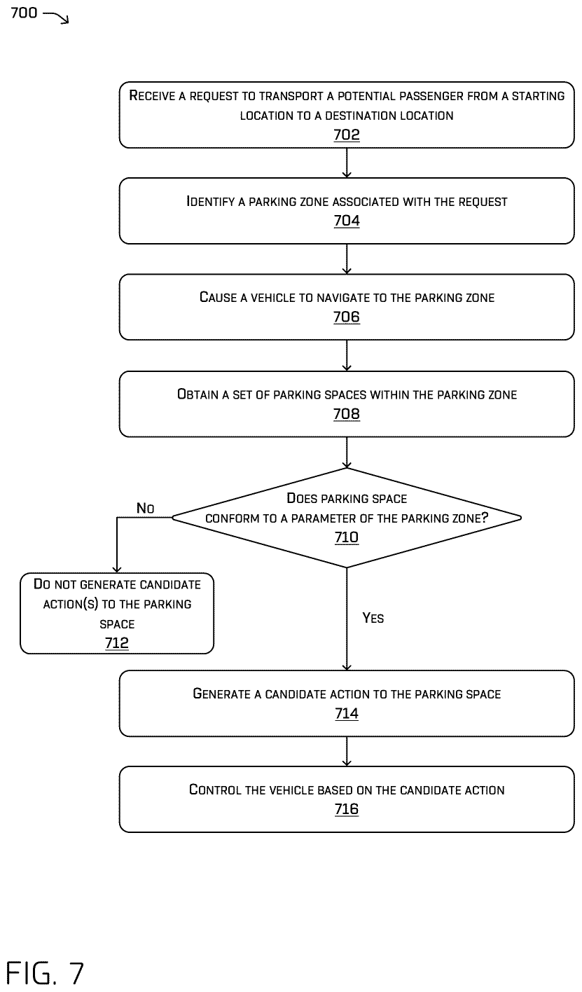

FIG. 7 is a flow diagram illustrating an example process 700 for receiving a request to transport a passenger, identify parking spaces based on parking zone(s) associated with the request, and/or controlling the vehicle based on the parking spaces. As described below, the example process 700 may be performed by one or more computer-based components configured to implement various functionalities described herein. For instance, process 700 may be performed by a parking management component and/or a planning component. As described above, the parking management component and/or a planning component may be integrated as an on-vehicle system in some examples. However, in other examples, the parking management component and/or a planning component may be integrated as a separate server-based system.

Process 700 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At operation 702, the vehicle may receive a request to transport a potential passenger from a starting location to a destination location. For example, a user may use a user device to request a ride (e.g., be transported from a starting location to a destination location). That is, the passenger may include a device which may be used to request rides from the vehicle. The passenger can use the device to access a ridesharing platform which may include a ride requesting interface. The ride requesting interface may allow the passenger to request a ride from a starting location to a destination location.

In such cases, the ridesharing platform may receive, from a passenger, a request for a ride from a starting location to a destination location. The request may include a starting location and/or a destination location as input to the ride requesting interface by the passenger. The starting location and/or the destination location may be exact locations, buildings, range of locations (e.g., range of coordinates), etc. In such cases, the passenger may submit the ride request to the rideshare platform to request a ride.

Based on receiving the request and the parking zones, the rideshare platform may display one or more recommended pickup and drop off locations. That is, the rideshare platform may receive the parking zones (or map data) and determine the closest zone to the starting location included in the request. Based on identifying the parking zones or parking spaces within a threshold distance to the requested pickup location, the rideshare platform may display a location associated with such parking zones or parking spaces to the device.

In such cases, the passenger may accept or reject the recommended pickup and drop off locations. That is, the passenger may view the recommended pickup and drop off locations and indicate that such locations are rejected. Based on rejecting the locations, the rideshare platform may cause the parking zones to be displayed via a user interface of the device. In such cases, the passenger may select, from the one or more pickup zones, a parking zone at which the passenger would like to be picked up and dropped off. In such cases, the rideshare platform may receive user input data that indicates that the user has selected a parking zone and/or confirmed the ride. Based on the user input data, the rideshare platform may send the request to a vehicle in the fleet. Upon receiving the request, the vehicle may proceed by navigating to and/or picking up the passenger.

At operation 704, the vehicle may identify a parking zone associated with the request. A parking zone may be geofence-like area that covers a region of the environment and that includes one or more parameters representing characteristic(s) of the parking zone. As described below, the parking management component may send the parking zone(s) to some or all vehicles in a fleet of vehicles.

For example, when generating the parking zone(s), the parking management component may receive map data. Map data may include information about the static object(s) and/or features of the environment such as road segment data, driving lane data, lane segment data, static object data (e.g., object type, object location, object characteristics, etc.), junction data, etc.

In some examples, the parking management component may generate the parking zone(s) based on the map data. As noted above, a parking zone may be a bounded region of the environment within which the vehicle can pickup and/or drop off a passenger. The size and/or dimensions of the parking zone(s) may be based on or correspond to a road segment, a driving lane, a lane segment, and/or the direction of travel associated therewith. Further, the size and/or dimensions may be based on environmental features such as the presence of fire hydrants, red curbs, allowable parking maneuvers, etc. As such, in these examples, the length of a parking zone may end a threshold distance from a fire hydrant such that the parking zone is not directly in front of the fire hydrant. In other examples, the parking management component may divide a single road segment, driving lane, and/or lane segment into multiple driving zones based on one portion allowing a first type of parking maneuver (e.g., parallel parking, perpendicular parking, double parking, curbside parking, etc.) and a second portion prohibiting such maneuvers.

In some examples, the parking zone(s) may include one or more parameters (or features) which may represent characteristics of the parking zone. The parking management component may receive the parameters from map data, third party resources (e.g., airports, hotels, cities, etc.), etc. The parameters may indicate which parking maneuvers are allowed or acceptable within the parking zone (e.g., curbside parking, double parking, perpendicular parking, parallel parking, etc.), a type of vehicle allowed to park within the zone (e.g., level 3 vehicle, level 5 vehicle, bidirectional vehicle, manual vehicle, etc.), an ability of a future passenger to select where to get picked up within the zone (e.g., some parking zones may be restricted such that there is only a limited number of pickup spots within the zone), etc. The parking management component may attach (e.g., encode) the parameter(s) to the associated parking zone(s).

In some examples, the parking management component may send the parking zones to a fleet of vehicles. That is, a fleet management component may manage and/or control the operation of a fleet of one or more vehicles within a specified geofence. In such cases, the fleet of vehicles may share a database that can include the parking zones. For example, the parking management component may send the parking zones to the database and the vehicles in the fleet may access the database and/or the parking zones stored therein while the vehicles navigate the environment.

Accordingly, the vehicle may identify the parking zone(s) by accessing the parking zones stored in the database and determine which parking zone(s) are associated with the starting location (e.g., which parking zone is the starting location located within).

At operation 706, the vehicle may cause a vehicle to navigate to the parking zone. Based on identifying the parking zone, the vehicle may navigate the environment to the parking zone.

At operation 708, the vehicle may obtain a set of parking spaces within the parking zone. Based on being within or otherwise within a threshold distance from the parking zone, the vehicle may identify candidate parking spaces within the parking zone. The vehicle may receive the parking spaces from map data and retrieve the parking spaces that are physically located with the parking zone.

At operation 710, the vehicle may determine whether the parking space conforms to a parameter of the parking zone. As noted above, the parking zone may include allowable parking maneuvers and/or one or more parameters which may indicate expectations and/or rules for the vehicle to follow within the zone. For example, the parameters of the parking zone may indicate that the vehicle can only perform a perpendicular parking maneuver in the parking zone. As such, the vehicle may receive the parking spaces within the pickup zone (from map data) that include a perpendicular parking maneuver. That is, the vehicle may filter through the one or more parking spaces within the pickup zone to identify the parking spaces that satisfy (or conform to) the parameters of the parking zone. As such, the vehicle may identify a subset of parking spaces (e.g., potentially less than all the parking spaces within the parking zone). Accordingly, if the parking space does not conform to the parameters (710: No), the vehicle may exclude the parking space from further operations. That is, at operation 712, the vehicle may not generate action(s) to the parking space.

In contrast, if the parking space conforms to the parameters (710: Yes), the vehicle may generate candidate actions to the parking space. At operation 714, the vehicle may generate a candidate action to the parking space. A candidate action may be a trajectory that includes a spatial representation of future movements of the vehicle in addition to one or more vehicle controls (e.g., velocity, acceleration, yaw, steering angle, etc.). That is, the candidate actions may include instructions that instruct the vehicle as to how to navigate a portion of the environment. The candidate actions can include instructions that cause the vehicle to perform a parking maneuver. In some examples, a candidate action may include multiple predicted states that can represent the state information of the vehicle at a specific location along the candidate action. State information may include location data, pose data (e.g., lateral offset data, longitudinal offset data, heading offset data), velocity data, acceleration data, and/or other types of data.

At operation 716, the vehicle may control the vehicle based on the candidate action. In some examples, the vehicle may generate a control trajectory which may be a combination of the one or more candidate actions. That is, to determine which of the one or more candidate actions to follow, the vehicle may use a tree structure. Accordingly, the vehicle may generate a tree structure that includes some or all of the candidate actions. A tree structure may include one or more nodes representing vehicle states at different action layers of the tree structure. Further, each vehicle state may include multiple candidate actions which the vehicle may follow. As described in more detail below, the planning component may use the tree structure to determine or otherwise select one or more of the candidate actions to follow from a node in the tree structure to a different node at the next layer of the tree structure. The planning component may determine which candidate actions to follow between layers of nodes based on one or more costs. Example techniques for generating a tree structure and determining a control trajectory based on the tree structure can be found, for example, in U.S. application Ser. No. 17/900,658, filed Aug. 21, 2022, and titled “Trajectory Prediction Based on a Decision Tree,” the contents of which is herein incorporated by reference in its entirety and for all purposes.

In some examples, the vehicle can determine a control trajectory based on the tree structure. The vehicle can evaluate some or all candidate actions when determining a control trajectory. A solution to the tree may result in a series of nodes of the one or more candidate actions which, when traversed (e.g., moving along and between differing trajectories and/or action layers of the tree structure), results in a control trajectory (e.g., output trajectory) having a lowest determined overall cost. An overall cost for the control trajectory may represent and/or be indicative of the combination of one or more sub-costs. A cost value can indicate the safety, progress, comfort, risk, convenience, and/or efficiency of a candidate trajectory. For instance, a high cost value may indicate heightened degree of risk, danger, inconvenience, discomfort, and/or inefficiency of the trajectory. In contrast, a low cost value may indicate a lower degree of risk, danger, inconvenience, and/or inefficiency of the trajectory. In some examples, sub-costs may include parking related costs, comfort related costs (e.g., acceleration cost, jerk cost, steering cost, path reference cost, etc.), legality related costs, policy related costs, safety related costs (e.g., lane changing costs), progress costs, debris cost, a lane blocking cost, a lane ending cost, an exit cost, an approach cost, a space cost, a payment cost, a yaw cost, adversarial cost(s), lane targeting cost (e.g., cost associated with the vehicle being located in a desired lane), cyclist related cost(s), and/or any other type of cost.

Upon determining the one or more sub-costs, the vehicle may determine or otherwise combine the sub-costs into a single overall cost. In various examples, differing cost types may be associated with differing weights based on, for example, importance. As a non-limiting examples, a parking cost or a safety cost may be associated with a higher weight than a comfort cost. Further, such costs may be weighted differently, and as such, different costs may affect the overall cost in different proportions. In some examples, the vehicle may determine to follow a control trajectory that has the lowest overall cost compared to the overall costs of other potential traversal paths between the candidate trajectories.

In some examples, the vehicle may follow the control trajectory to a parking space. Upon determining the control trajectory from the tree search, the vehicle may follow the control trajectory to a parking space within the parking zone. As such, the vehicle may be controlled based on the parking zone. In some examples, the vehicle may perform similar or identical operations when dropping off the passenger.

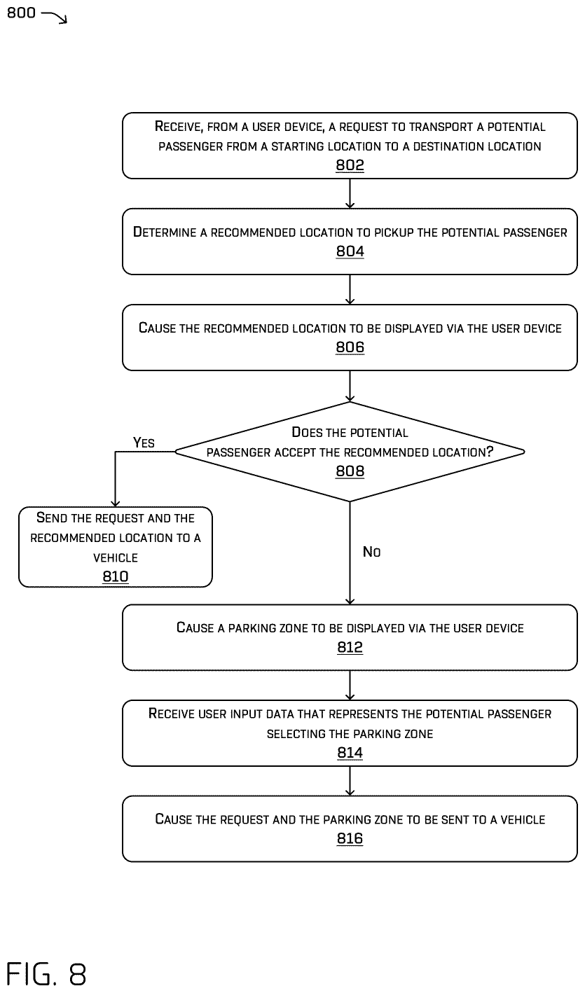

FIG. 8 is a flow diagram illustrating an example process 800 for leveraging parking zones when requesting a ride from an autonomous vehicle using a user device. As described below, the example process 800 may be performed by one or more computer-based components configured to implement various functionalities described herein. For instance, process 800 may be performed by a ridesharing component. As described above, the ridesharing component may be integrated as an on-vehicle system in some examples. However, in other examples, the ridesharing component may be integrated as a separate server-based system.

Process 800 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At operation 802, the ridesharing component may receive, from a user device, a request to transport a potential passenger from a starting location to a destination location. That is, a passenger may include a device which may be used to request rides from the vehicle. The device may be a mobile device (e.g., phone, wearable, tablet, etc.) or a stationary device (e.g., desktop, etc.). The passenger can use the device to access a ridesharing platform which may include a ride requesting interface. The ride requesting interface may allow the passenger to request a ride from a starting location to a destination location.

In such cases, the ridesharing platform may receive, from a passenger, a request for a ride from a starting location to a destination location. The request may include a starting location and/or a destination location as input to the ride requesting interface by the passenger. The starting location and/or the destination location may be exact locations, buildings, range of locations (e.g., range of coordinates), etc. In such cases, the passenger may submit the ride request to the rideshare platform to request a ride.

At operation 804, the ridesharing component may determine a recommended location to pick up the potential passenger. That is, based on receiving the request, the rideshare platform may display one or more recommended pickup and drop off locations. For instance, the rideshare platform may receive the parking zones (or map data) and determine the closest zone to the starting location included in the request. Based on identifying the parking zones or parking spaces within a threshold distance to the requested pickup location, the rideshare platform may display a location associated with such parking zones or parking spaces to the device.

At operation 806, the ridesharing component may cause the recommended location to be displayed via the user device. As noted above, the ridesharing component may display the recommended location to a user interface of a user device used by the passenger such that the passenger is able to view the recommended location.

At operation 808, the ridesharing component may determine whether the potential passenger accepted the recommended location. That is, the passenger may view the recommended pick up location and determine whether the location is suitable. If the passenger accepts the pickup location (808: Yes), the ridesharing component may send the ride request and the recommended location to a vehicle. That is, at operation 810, the ridesharing component may send the request and the recommended location to the vehicle such that the vehicle may proceed to pick up the passenger.

In contrast, if the passenger rejects the recommended location (808: No), the vehicle may display parking zones via the user interface. That is, at operation 812, the ridesharing component may cause a parking zone to be displayed via the user device. As noted above, the parking zones may be a region of the environment that encompasses one or more parking spaces. In such cases, the ridesharing component may retrieve the parking zones and cause such parking zones to be displayed via the user interface.

At operation 814, the ridesharing component may receive user input data that represents the potential passenger selecting the parking zone. In such cases, the passenger may select, from the one or more pickup zones, a parking zone at which the passenger would like to be picked up and dropped off. In such cases, the rideshare platform may receive user input data that indicates that the user has selected a parking zone and/or confirmed the ride.

At operation 816, the ridesharing component may cause the request and the parking zone to be sent to a vehicle. Based on the user input data, the rideshare platform may send the request to a vehicle in the fleet. Upon receiving the request, the vehicle may proceed by navigating to and/or picking up the passenger.

### Example Clauses

A: A system comprising: one or more processors; and one or more non-transitory computer-readable media storing computer-executable instructions that, when executed, cause the system to perform operations comprising: receiving, from a rideshare application associated with an autonomous vehicle, a request to transport a potential passenger from a starting location to a destination location; identifying, based at least in part on a first parameter, a parking zone from a plurality of parking zones associated with the request; causing the autonomous vehicle to navigate to the parking zone; determining, based at least in part on the autonomous vehicle being within a threshold distance of the parking zone, a set of parking spaces within the parking zone; determining, based at least in part on a second parameter associated with the parking zone, a subset of parking spaces of the set of parking spaces; generating a candidate action to navigate to a parking space of the subset of parking spaces; and controlling the autonomous vehicle based at least in part on the candidate action.

B: The system of paragraph A, wherein the parking zone is stored in a database accessible to a fleet of vehicles, the operations further comprising: receiving, from a sensor associated with the autonomous vehicle, sensor data; determining, based at least in part on the sensor data, an event; and causing, based at least in part on the event, the parking zone to be updated in the database.

C: The system of paragraph B, wherein causing the parking zone to be updated in the database is performed by the autonomous vehicle or a remote operation system.

D: The system of paragraph B, wherein causing the parking zone to be updated comprises: determining, based at least in part on the event, a modified parking zone associated with the parking zone, wherein determining the modified parking zone comprises modifying a dimension of the parking zone.

E: The system of paragraph A, wherein the parking zone includes a first parameter that is at least one of: a type of weather, a safety constraint, or a time of day.

F: One or more non-transitory computer-readable media storing instructions executable by one or more processors, wherein the instructions, when executed, cause a system to perform operations comprising: receiving a request to transport a potential passenger from a starting location to a destination location; identifying, based at least in part on a first parameter, a parking zone from a plurality of parking zones associated with the request; causing a vehicle to navigate to the parking zone; receiving a set of parking spaces within the parking zone; determining, based at least in part on a second parameter associated with the parking zone, a subset of parking spaces of the set of parking spaces; and generating a candidate action to navigate to a parking space of the set of parking spaces.

G: The one or more non-transitory computer-readable media of paragraph F, wherein the parking zone is stored in a database accessible to a fleet of vehicles, the operations further comprising: receiving, from a sensor associated with the vehicle, sensor data; determining, based at least in part on the sensor data, an event; and causing, based at least in part on the event, the parking zone to be updated in the database.

H: The one or more non-transitory computer-readable media of paragraph G, wherein causing the parking zone to be updated in the database is performed by the vehicle or a remote operation system.

I: The one or more non-transitory computer-readable media of paragraph G, wherein causing the parking zone to be updated comprises: determining, based at least in part on the event, a modified parking zone associated with the parking zone, wherein determining the modified parking zone comprises modifying a dimension of the parking zone.

J: The one or more non-transitory computer-readable media of paragraph F, wherein the parking zone includes a first parameter that is at least one of: a type of weather, an environmental restriction, a safety constraint, or a time of day.

K: The one or more non-transitory computer-readable media of paragraph F, wherein identifying the parking zone is based at least in part on: receiving, from a database, the plurality of parking zones; and determining that the destination location is at a position within the parking zone of the plurality of parking zones.

L: The one or more non-transitory computer-readable media of paragraph F, wherein the second parameter includes at least one of: an allowed type of parking maneuver, a rule of an environment, or a type of vehicle.

M: The one or more non-transitory computer-readable media of paragraph F, the operations further comprising: controlling the vehicle based at least in part on the candidate action.

N: A method comprising: receiving a request to transport a potential passenger from a starting location to a destination location; identifying, based at least in part on a first parameter, a parking zone from a plurality of parking zones associated with the request; causing a vehicle to navigate to the parking zone; receiving a set of parking spaces within the parking zone; determining, based at least in part on a second parameter associated with the parking zone, a subset of parking spaces of the set of parking spaces; and generating a candidate action to navigate to a parking space of the set of parking spaces.

O: The method of paragraph N, wherein the parking zone is stored in a database accessible to a fleet of vehicles, further comprising: receiving, from a sensor associated with the vehicle, sensor data; determining, based at least in part on the sensor data, an event; and causing, based at least in part on the event, the parking zone to be updated in the database.

P: The method of paragraph O, wherein causing the parking zone to be updated in the database is performed by the vehicle or a remote operation system.

Q: The method of paragraph O, wherein causing the parking zone to be updated comprises: determining, based at least in part on the event, a modified parking zone associated with the parking zone, wherein determining the modified parking zone comprises modifying a dimension of the parking zone.

R: The method of paragraph N, wherein the parking zone includes a first parameter that is at least one of: a type of weather, an environmental restriction, a safety constraint, or a time of day.

S: The method of paragraph N, wherein identifying the parking zone is based at least in part on: receiving, from a database, the plurality of parking zones; and determining that the destination location is at a position within the parking zone of the plurality of parking zones.

T: The method of paragraph N, wherein the second parameter includes at least one of: an allowed type of parking maneuver, a rule of an environment, or a type of vehicle.

U: A system comprising: one or more processors; and one or more non-transitory computer-readable media storing computer-executable instructions that, when executed, cause the system to perform operations comprising: receiving, from a user interface associated with a user device, a request to transport a user from a starting location to a destination location; determining, based at least in part on the request, a recommended location to pickup or drop off the user; causing the recommended location to be displayed via the user interface; receiving first user input data that represents a rejection of the recommended location; identifying, based at least in part on a plurality of parameters associated with a plurality of parking zones, a subset of parking zones of the plurality of parking zones; causing, based at least in part on the rejection, the subset of parking zones to be displayed to the user interface; receiving second user input data that represents selection of a parking zone of the subset of parking zones and a location within the parking zone; and causing the second user input data to be sent to a vehicle.

V: The system of paragraph U, wherein the parking zone is represented on the user interface by a user interface element, the operations further comprising: determining likelihood data associated with locations within the parking zone that the vehicle will pick up the user; determining a modified user interface element that is associated with the parking zone; and causing, based at least in part on the likelihood data, the modified user interface element to be displayed via the user interface.

W: The system of paragraph U, wherein determining the recommended location is based at least in part on: retrieving, from a database, the plurality of parking zones in a region of an environment associated with the starting location; and determining the parking zone of the plurality of parking zones based at least in part on at least one of: a shortest distance to the starting location, a convenience level of the user, a fastest ride to the destination location, or a safety of the user.

X: The system of paragraph U, wherein the parking zone is generated based at least in part on map data and a third party, the parking zone covering a region of an environment and including a parameter of the plurality of parking zones.

Y: The system of paragraph U, wherein the parking zone includes a first parameter that is at least one of: a type of weather, a safety constraint, or a time of day.

Z: One or more non-transitory computer-readable media storing instructions executable by one or more processors, wherein the instructions, when executed, cause a system to perform operations comprising: receiving, from a user interface associated with a user device, a request to transport a user from a starting location to a destination location; determining, based at least in part on the request, a recommended location to pickup or drop off the user; causing the recommended location to be displayed via the user interface; causing a parking zone to be displayed to the user interface; and causing the request and the parking zone to be sent to a vehicle.

AA: The one or more non-transitory computer-readable media of paragraph Z, wherein the parking zone is represented on the user interface by a user interface element, the operations further comprising: determining likelihood data associated with locations within the parking zone that the vehicle will pick up the user; determining a modified user interface element that is associated with the parking zone; and causing, based at least in part on the likelihood data, the modified user interface element to be displayed via the user interface.

AB: The one or more non-transitory computer-readable media of paragraph Z, wherein determining the recommended location is based at least in part on: retrieving, from a database, a set of parking zones in a region of an environment associated with the starting location; and determining the parking zone of the set of parking zones is based at least in part on at least one of: a shortest distance to the starting location, a convenience level of the user, a fastest ride to the destination location, or a safety of the user.

AC: The one or more non-transitory computer-readable media of paragraph Z, wherein the parking zone is generated based at least in part on map data and a third party, the parking zone covering a region of an environment and including a parameter.

AD: The one or more non-transitory computer-readable media of paragraph Z, wherein the parking zone includes a first parameter that is at least one of: a type of weather, an environmental restriction, a safety constraint, or a time of day.

AE: The one or more non-transitory computer-readable media of paragraph AD, wherein controlling the vehicle based at least in part on the parking zone comprises: identifying a set of parking spaces within the parking zone; determining, based at least in part on a parameter of the parking zone, a subset of parking spaces of the set of parking spaces; generating a candidate action to a parking space of the subset of parking spaces; and controlling the vehicle based at least in part on the candidate action.

AF: The one or more non-transitory computer-readable media of paragraph Z, wherein causing the request and the parking zone to be sent to the vehicle is based at least in part on receiving second user input data that represents selection of at least a portion of the parking zone.

AG: The one or more non-transitory computer-readable media of paragraph Z, wherein causing the parking zone to be displayed is based at least in part on: receiving user input data that represents a rejection of the recommended location.

AH: A method comprising: receiving, from a user interface associated with a user device, a request to transport a user from a starting location to a destination location; determining, based at least in part on the request, a recommended location to pickup or drop off the user; causing the recommended location to be displayed via the user interface; causing a parking zone to be displayed to the user interface; and causing the request and the parking zone to be sent to a vehicle.

AI: The method of paragraph AH, wherein the parking zone is represented on the user interface by a user interface element, the operations further comprising: determining likelihood data associated with locations within the parking zone that the vehicle will pick up the user; determining a modified user interface element that is associated with the parking zone; and causing, based at least in part on the likelihood data, the modified user interface element to be displayed via the user interface.

AJ: The method of paragraph AH, wherein determining the recommended location is based at least in part on: retrieving, from a database, a set of parking zones in a region of an environment associated with the starting location; and determining the parking zone of the set of parking zones is based at least in part on at least one of: a shortest distance to the starting location, a convenience level of the user, a fastest ride to the destination location, or a safety of the user.

AK: The method of paragraph AH, wherein the parking zone is generated based at least in part on map data and a third party, the parking zone covering a region of an environment and including a parameter.

AL: The method of paragraph AH, wherein the parking zone includes a first parameter that is at least one of: a type of weather, an environmental restriction, a safety constraint, or a time of day.

AM: The method of paragraph AL, wherein controlling the vehicle based at least in part on the parking zone comprises: identifying a set of parking spaces within the parking zone; determining, based at least in part on a parameter of the parking zone, a subset of parking spaces of the set of parking spaces; generating a candidate action to a parking space of the subset of parking spaces; and controlling the vehicle based at least in part on the candidate action.

AN: The method of paragraph AH, wherein causing the request and the parking zone to be sent to the vehicle is based at least in part on receiving second user input data that represents selection of at least a portion of the parking zone.

While the example clauses described above are described with respect to particular implementations, it should be understood that, in the context of this document, the content of the example clauses can be implemented via a method, device, system, a computer-readable medium, and/or another implementation. Additionally, any of examples A-AN may be implemented alone or in combination with any other one or more of the examples A-AN.

### Conclusion

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code modules and/or computer-executable instructions executed by one or more computers or processors, hardware, or some combination thereof. Some or all of the methods may alternatively be embodied in specialized computer hardware.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a”means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
one or more non-transitory computer-readable media storing computer-executable instructions that, when executed, cause the system to perform operations comprising:
receiving, from a rideshare application associated with an autonomous vehicle, a request to transport a potential passenger from a starting location to a destination location;
identifying, based at least in part on a first parameter, a parking zone from a plurality of parking zones associated with the request;
causing the autonomous vehicle to navigate to the parking zone;
determining, based at least in part on the autonomous vehicle being within a threshold distance of the parking zone, a set of parking spaces within the parking zone;
determining, based at least in part on a second parameter associated with the parking zone, a subset of parking spaces of the set of parking spaces;
generating a candidate action to navigate to a parking space of the subset of parking spaces; and
controlling the autonomous vehicle based at least in part on the candidate action.

2. The system of claim 1, wherein the parking zone is stored in a database accessible to a fleet of vehicles, the operations further comprising:
receiving, from a sensor associated with the autonomous vehicle, sensor data;
determining, based at least in part on the sensor data, an event; and
causing, based at least in part on the event, the parking zone to be updated in the database.

3. The system of claim 2, wherein causing the parking zone to be updated in the database is performed by the autonomous vehicle or a remote operation system.

4. The system of claim 2, wherein causing the parking zone to be updated comprises:
determining, based at least in part on the event, a modified parking zone associated with the parking zone, wherein determining the modified parking zone comprises modifying a dimension of the parking zone.

5. The system of claim 1, wherein the parking zone includes a first parameter that is at least one of:
a type of weather,
an environmental restriction,
a safety constraint, or
a time of day.

6. One or more non-transitory computer-readable media storing instructions executable by one or more processors, wherein the instructions, when executed, cause a system to perform operations comprising:
receiving a request to transport a potential passenger from a starting location to a destination location;
identifying, based at least in part on a first parameter, a parking zone from a plurality of parking zones associated with the request;
causing a vehicle to navigate to the parking zone;
receiving a set of parking spaces within the parking zone;
determining, based at least in part on a second parameter associated with the parking zone, a subset of parking spaces of the set of parking spaces; and
generating a candidate action to navigate to a parking space of the set of parking spaces.

7. The one or more non-transitory computer-readable media of claim 6, wherein the parking zone is stored in a database accessible to a fleet of vehicles, the operations further comprising:
receiving, from a sensor associated with the vehicle, sensor data;
determining, based at least in part on the sensor data, an event; and
causing, based at least in part on the event, the parking zone to be updated in the database.

8. The one or more non-transitory computer-readable media of claim 7, wherein causing the parking zone to be updated in the database is performed by the vehicle or a remote operation system.

9. The one or more non-transitory computer-readable media of claim 7, wherein causing the parking zone to be updated comprises:
determining, based at least in part on the event, a modified parking zone associated with the parking zone, wherein determining the modified parking zone comprises modifying a dimension of the parking zone.

10. The one or more non-transitory computer-readable media of claim 6, wherein the parking zone includes a first parameter that is at least one of:
a type of weather,
an environmental restriction,
a safety constraint, or
a time of day.

11. The one or more non-transitory computer-readable media of claim 6, wherein identifying the parking zone is based at least in part on:
receiving, from a database, the plurality of parking zones; and
determining that the destination location is at a position within the parking zone of the plurality of parking zones.

12. The one or more non-transitory computer-readable media of claim 6, wherein the second parameter includes at least one of:
an allowed type of parking maneuver,
a rule of an environment, or
a type of vehicle.

13. The one or more non-transitory computer-readable media of claim 6, the operations further comprising:
controlling the vehicle based at least in part on the candidate action.

14. A method comprising:
receiving a request to transport a potential passenger from a starting location to a destination location;
identifying, based at least in part on a first parameter, a parking zone from a plurality of parking zones associated with the request;
causing a vehicle to navigate to the parking zone;
receiving a set of parking spaces within the parking zone;
determining, based at least in part on a second parameter associated with the parking zone, a subset of parking spaces of the set of parking spaces; and
generating a candidate action to navigate to a parking space of the set of parking spaces.

15. The method of claim 14, wherein the parking zone is stored in a database accessible to a fleet of vehicles, further comprising:
receiving, from a sensor associated with the vehicle, sensor data;
determining, based at least in part on the sensor data, an event; and
causing, based at least in part on the event, the parking zone to be updated in the database.

16. The method of claim 15, wherein causing the parking zone to be updated in the database is performed by the vehicle or a remote operation system.

17. The method of claim 15, wherein causing the parking zone to be updated comprises:
determining, based at least in part on the event, a modified parking zone associated with the parking zone, wherein determining the modified parking zone comprises modifying a dimension of the parking zone.

18. The method of claim 14, wherein the parking zone includes a first parameter that is at least one of:
a type of weather,
an environmental restriction,
a safety constraint, or
a time of day.

19. The method of claim 14, wherein identifying the parking zone is based at least in part on:
receiving, from a database, the plurality of parking zones; and
determining that the destination location is at a position within the parking zone of the plurality of parking zones.

20. The method of claim 14, wherein the second parameter includes at least one of:
an allowed type of parking maneuver,
a rule of an environment, or
a type of vehicle.
